(19) United States
(12) Patent Application Publication
(10) Pub. No.: US 2006/0142147 A1
(43) Pub. Date: Jun. 29, 2006

(54) Catalysts compositions for the polymerization and copolymerization of alpha-olefins

(76) Inventors: Jose Sancho Royo, Madrid (ES); Carlos Alonso Moreno, Ciudad Real (ES); Fernando Carrillo Hermosilla, Ciudad Real (ES); Antonio Otero Montero, Ciudad Real (ES); Antonio Antinolo Garcia, Ciudad Real (ES)

Correspondence Address: INTELLECTUAL PROPERTY / TECHNOLOGY LAW, PO BOX 14329, RESEARCH TRIANGLE PARK, NC, 27709, US

(21) Appl. No.: 11/292,480

(22) Filed: Dec. 2, 2005

(30) Foreign Application Priority Data
Dec. 3, 2004 (EP) 04380249.5

(51) Int. Cl. C08F 4/44; B01J 31/00; C07F 17/00

(52) U.S. Cl. 502/117; 526/127; 526/160; 526/943; 526/348.5; 526/348.6; 556/53

(57) ABSTRACT

A catalyst system, a polymerization process using that catalyst system and polymers produced therefrom. The catalytic system results from the combination of bridged indenyl metallocenes of general formula I and an organoaluminium or boron perfluorinated co-catalyst, where M is a transition metal of Group 4 of the Periodic Table of the elements, Q is a divalent substituent and X1 and X2 are monovalent anionic ligands. Polyethylene copolymers made with such catalysts can have from narrow to broad to bimodal molecular weight distribution and melt indexes from about 0 to higher than 10 without the need of molecular weight regulators, depending on proper selection of the indenyl substituent, number of substituents (single or both indenes substituted) and the type of stereoisomeric form used: pure (racemic or meso) or mixtures thereof.

### FIELD OF THE INVENTION

The present invention relates to a series of bridged indenyl metallocenes substituted at the 3 position, to a catalyst system containing them, to a polymerization process using that catalyst system and to polymers produced therefrom. In particular it relates to a pure stereoisomer form (racemic or meso) or mixtures thereof, specially useful for producing ethylene (co)polymers of desired molecular weight and molecular weight distribution, by an appropriate selection of the type of substituent and the type of isomer.

### BACKGROUND OF THE INVENTION

Since the discovery in the early 1980s of alumoxane as co-catalysts in combination with transition metal “cyclopentadiene-type” compounds commonly known as metallocenes to make polyolefin polymers, an ever increasing number of the later compounds are being still described.

Three have been the main primary focus for the development of new metallocene-type catalysts: increasing productivity to lowering catalyst cost, fitting catalysts systems and compositions to already existing polymerization processes: gas phase, slurry or solution by way of heterogeneization (for the first two cases) and developing a wider range of polymers and copolymers with improved physical properties (processability, mechanical, optical, etc) by the control of molecular weight, molecular weight distribution, incorporation of co-monomer and molecular polymer chain architecture.

While it is known in the art that the use of bridged indenyl metallocene complexes to make ethylene polymers and copolymers lead to final catalyst systems with high activities, good co-monomer incorporation efficiencies and somewhat narrow molecular weight distribution, all of them yield polyethylenes of high molecular weight (lower than about 1 melt indexes) in the absence of molecular weight regulators, being hydrogen the most commonly used.

Even though hydrogen can be used industrially to make ethylene (co)polymers of higher than about 0.1 to about 12 melt indexes with such bridged indenyl metallocenes, its use have some additional drawbacks: the use of an additional component along the polymerization feed besides monomers and catalyst, the need to finely control hydrogen to monomer ratios because of the high response of metallocenes regarding dependence of molecular weight of polymer and hydrogen concentration in the feed and in some cases, particularly under slurry type processes, production of increasing amount of fines.

On the other hand, metallocenes containing non-bridged cyclopentadienyl or substituted cyclopentadienyl ligands yield ethylene (co)polymers with higher than zero and about 1 and higher melt indexes without the use of hydrogen, but they show lower activities and lower co-monomer incorporation efficiencies than the above-mentioned indenyl bridged metallocenes.

It would be highly desirable to have at disposal new bridged indenyl metallocenes showing all together: high activities, high incorporation of co-monomer efficiencies and no need of hydrogen as a molecular weight regulator to make ethylene (co)polymers with melt indexes from about 0.2 up to 12 in addition to being able to optionally make polymers of higher molecular weight.

It has now been discovered that simple and predictable changes in the length of the alkyl substituent at the 3 position of the indenyl ligand in 3-substituted bridged metallocenes allows control of molecular weight of ethylene (co)polymers produced with them in an easy and systematically controlled way, making it possible to prepare products with a wide range of melt indexes from about zero to about 12 without the need of using hydrogen as a molecular weight regulator.

Additionally, a combination of factors: use of pure stereoisomer (rac or meso), mixtures of isomers (rac and meso), length of the substituent and combination of different lengths of substituents (different on each of indenyl rings) allows the production of a very wide type of (co)polymers from high to low molecular weight without the use of hydrogen and with narrow to broad to bimodal molecular weight distribution.

It is well recognized in the art that variations in the molecular structure of stereorigid chiral metallocenes including the nature and position of substitutions on the “cyclopentadienyl-type” ligands can have significant effects upon both the properties of polymers made with them. In particular, the size and location of substituents on the cyclopentadienyl ring moiety of metallocenes has been found to affect activity, stereoselectivity and molecular weight. The use of specific structures of the metallocenes is critical to achieve determined polymer chain characteristics, polymer product performance and optimal catalyst fit to process conditions and operability.

In the prior art many references of bridged indenyl metallocenes claiming broad general formulae encompassing a vast number of bridged metallocenes are described but it will be widely accepted by skilled individuals in the art that is very unlikely that all of the metallocenes within such claimed broad general formulae have actually been prepared and fully evaluated from their polymerization performance and the properties of the polymers obtained by the use of them.

Most importantly, not only have not all the metallocenes included in these broad general formulae most likely been synthesized, but also their use for producing specific types of polymers and copolymers could not have been predicted before the present invention.

It has been also noted by those skilled in the art that the effects of particular changes in the chemical structure of the metallocene upon the properties of the polymers made using such metallocene as catalysts is still mostly an empirical matter and continuous new designs and experiments must be conducted to determine the specific effect of such changes.

Prior to the findings of the present invention, there does not appear to have been any systematic work suggesting what effect substituents at 3-position on indenyl bridged metallocenes used as catalysts as racemic, meso or rac meso mixtures would have on the main properties of polyethylene polymers and copolymers made therefrom.

In EP 0 700 937 a large variety of bridged indenyl metallocenes are disclosed including different bridge types moieties but regarding 3-substituted examples only the rac silyl bis (3-methyl indenyl) and a mixture of rac/meso ethylenebis (3-trialkylsilylindenyl) zirconocenes are specifically described. Additionally there is no disclosure as how other types of corresponding metallocenes with different substituents to methyl or trialkylsylil, being disubstituted or monosubstituted like those included within the scope of the present invention being in turn used as substantially pure isomers or in mixtures could be exploited to obtain different type of polyethylene products.

EP 0 743 324 B1 describes the use of mixtures of racemic and meso isomers of bridged metallocenes catalysts for making polyethylene with polydispersity index at least 3.0. Metallocenes described therein include those pertaining to a broad general formula but in fact only one metallocene is exemplified, the one with a methyl substituent in the 2-position producing polyethylenes with polydispersity indexes ranging from 3.7 to 4.6.

Bis (1-indenyl) metallocenes substituted in the 2 and/or 4 position are particularly important for the production of highly isotactic polypropylene as described by Spaleck et al. Angew. Chem., Int. Ed. Engl. 1992, 31, 1347.

EP 0 537 686 discloses the use of specially substituted indenyl bridged metallocenes preferably on the 2-position. Emphasis is made on the importance of separating out undesirable meso stereoisomers from the catalyst composition in the polypropylene preparation when highly isotactic polypropylene is to be produced.

In the specific examples when polythylene is made only one 3 -substituted metallocene substituent being methyl, Example 14) is described in turn only as its racemic isomer producing polyethylene with very narrow molecular weight distribution.

WO03106470 describes the use of very specific multiple substituted indenyl metallocenes containing preferably one indenyl disubstituted at least in the 2,3-position, therefore with substitution at the 2-position and simultaneously with 3-position, with the main objective of making ethylene propylene copolymers having high molecular weight.

U.S. Pat. No. 6,448,350 provides a process for the preparation of ethylene copolymers in the presence of catalysts comprising specifically carbon-bridged 3-substituted indenyl metallocenes. Besides being characterized specifically by the bridge moiety (single carbon atom), there is no disclosure of how the different factors: nature of substituent, single or double substitution, rac or meso isomer, can be combined to obtain a wide range of targeted copolymer products characterized by their molecular weights and molecular weight distribution.

The same compounds as in U.S. Pat. No. 6,448,350 are described in Macromol. Chem. Phys. 2001, 202, 2010 by Balboni et al. along with the silyl bridge metallocene: dimethylsilylbis (3-iPropyl indenyl) zirconium dichloride showing in this case low activity and low molecular weight atactic polypropylene in the polymerization of propylene.

A few more specific 3-substituted bridged indenyl metallocenes are also previously described but in all cases their polymerization behavior has been studied only for the preparation of polypropylene.

The one with t-Butyl substituent: dimethylsilylbis (3-tBu 1-indenyl) zirconium dichloride by Ewen, J. A. Macromol. Symp., 1995, 89, 181 and U.S. Pat. No. 5,459,117 is employed to control desired polymer properties of polypropylene. Undesirable nonstereospecific meso stereoisomer is separated and the racemic isomer is used to obtain high isotactic polypropylene.

Rac and Meso diastereoisomers of an asymmetric Zirconocene dichloride (Me₂Si(3-benzylindenyl)(indenyl)ZrCl₂) are disclosed by Repo et al. Organometallics 2004, 16, 3759-3762. The properties as catalyst of said Zirconocenes in the polymerization of propene have been studied, showing that they produce isotactic polypropenes.

Warren et al. in Organometallics 2000, 19, 127-134, describe the synthesis of 1,3 doubly bridged metallocenes by intramolecular reductive coupling of pendant olefins. International patent application WO 99/11648, describes metallocenes and their use as catalyst for hydrogenation of prochiral olefins and hydrosilylation of ketones. The catalytic properties of ansa-zirconocenes of formula Me₂Si(3-p-tolylindenyl)₂ZrCl₂ and Me₂Si(2-p-tolylindenyl)₂ZrCl₂ is studied by Cheol Yoon et al. (J. Organometallic Chem. 1998, 559, 149-156) for the synthesis of polypropylene. The synthesized polypropylenes are found to have high isotacticity.

Resconi et al (Polymer preprints 1997, 38, 776-777) describe an NMR study of the polymerization properties of different metallocenes. Different experiments are disclosed in which the effect of temperature and ligand structure is discussed. The mechanism of chain transfer to the monomer is discussed.

EP 0 399 348 describes different metallocenes used as catalyst in the synthesis of polyolefins. The metallocenes used are mainly those in which aromatic residues of the two ligands of the metallocene are different (for example, different combinations of substituted cyclopentenyl and fluorenyl ligands).

A monosusbtituted “non symmetrical” methyl metallocene dimethylsilyl(indenyl)(3-Methyl, 1 -indenyl) zirconium dichloride is described by Bravakis,A. M et al. Macromolecules, 1998, 31, 1000 and isolated as its meso and racemic stereoisomer. Both isomers have been evaluated for propylene polymerization. Meso isomer yields very low Mw PP and low activity while rac isomer yields partially isotactic PP at reasonable productivities.

In none of the prior art references, however, is there evidence of a systematic preparation of different bridged 3-substituted metallocenes with a programmed variation of the size of substituent and its number (mono o disubstitution), isolation of both racemic and meso isomers and of any teaching as how to combine all of this factors together to make a wide variety of polethylene products as is achieved by the present invention.

An object of the present invention then is to provide certain new bridged substituted 3-indenyl-containing metallocenes.

Still another object of the present invention is to provide polymerization catalysts systems employing the specific above-mentioned metallocenes. The catalyst composition used in the present invention comprises the racemic and meso stereoisomers of 3-substituted bridged metallocene catalysts and mixtures thereof.

Still yet another object of the present invention is to provide processes for the polymerization of olefins using such meatallocene catalyst systems.

Yet another object of the present invention is to provide a wide variety of types of ethylene polymers and copolymers from low to high molecular weight, narrow to broad and even bimodal molecular weight distribution, by adequate selection of the size of substituent, the use of symmetrical (disubstituted) or unsymmetrical metallocenes being coupled with the use in each case of the racemic or meso isomers or mixtures thereof in appropriate proportions.

Preferably the invention is directed to the use of supported catalysts systems comprising above mentioned metallocenes for producing ethylene (co)polymers of desired molecular weight and molecular weight distribution, by judicious selection of the type of substituent and the type of isomer.

In one preferred particular embodiment specific copolymers of desirable molecular weight and molecular weight distribution are obtained optionally without the use of hydrogen as a molecular weight regulator, simply by proper selection of the indenyl substituent within the metallocene, yielding precisely targeted products. Use of hydrogen is typically needed when using other bridged indenyl-containing metallocenes of the previous state of art for preparation of ethylene polymers and copolymers with MI from about 1 to about 7 or higher.

Avoiding the use of hydrogen when metallocenes are used as polymerization catalysts is usually highly advantageous in practice because of the need of fine regulation and control of this extra component within the polymerization feed and also because other frequently observed negative effects in industrial practice (increase of fines production, and decrease of catalyst co-monomer incorporation efficiency) are present when hydrogen is used.

Nevertheless hydrogen can optionally be used with the metallocenes of the present invention for making additionally targeted products by selection of certain specific additionally provided metallocenes, as another alternative choice.

It has now been surprisingly discovered that the metallocenes object of the invention with substituents on the 3 position being disubstituted or monosubstituted can produce in the presence of suitable co-catalyst polyethylenes with unexpected versatility in terms of molecular weight and molecular weight distribution depending on combination of three factors: a) the size of substituent, b) the use of single substantially pure isomers (rac or meso isomers) or mixtures thereof and c) substitution type (di or monosubstitution) due to particular relationship and interdependence of all above-mentioned factors on the polymers produced.

Generally speaking bridged indenyl-containing metallocenes non-substituted or containing methyl groups as substituents on cyclopentadienyl ring of the indenyl ligand already known in the art, in the absence of hydrogen produce polyethylenes with high molecular weight (MI about 0 and lower than about 1) when used as catalysts in combination with suitable co-catalysts. We have found that this is also the case when the substituent is an ethyl group, but unexpectedly corresponding metallocene with larger than ethyl, e.g., propyl or larger, substituents yield under the same conditions polyethylenes with higher than 1 MI, between about 1 to about 20 or higher under the same conditions. Non-symmetric metallocenes with different substituents on each indene moiety can also be used to modulate or to adjust the molecular weight to a desired one.

Additionally the racemic and meso isomers of the metallocenes of the present invention produce polyethylenes of different molecular weights, very different in some cases like with disubstituted metallocenes when substituents are methyl or ethyl, and rather similar in other cases specially with unsymmetrical long chain substituents (larger than ethyl) allowing the preparation of from narrow to broad to narrow bimodal to broad bimodal molecular weight distribution polyethylenes, by judicious choice of combination of: isomer content, size of the substituent (small: methyl or ethyl or larger: for example propyl or butyl) and type of metallocene (disubstituted or monosubstituted), as will be shown below. Co-monomer incorporation into the copolymer also have been found dependant on the size of substituent and the type of isomer (rac or meso).

As a final consequence, with the inventive metallocenes described more fully hereinafter, it is possible to have at hand a very versatile and practical tool to control and produce different classes of ethylene polymers and copolymers.

### SUMMARY OF THE INVENTION

In accordance with the present invention, there are provided new bridged metallocene compounds containing two substituted indenyl ligands joined by a bridging group and complexed to a metal atom, of formula (I): 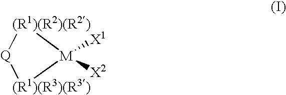
wherein:
M is a transition metal atom selected from the group consisting of the atoms of Group 4 of the Periodic Table;
R¹ is an indenyl ligand;
Q is a divalent group of formula ═SiR⁴R⁵ or —CH R⁴—CH R⁵—; wherein R⁴ and R⁵ are, independently, hydrogen atoms or monovalent radicals selected from halogen, C₁-C₂₀ alkyl, C₆-C₂₀ aryl, C₂-C₂₀ alkenyl, C₇-C₂₀ arylalkyl and C₇-C₂₀ alkylaryl, optionally containing oxygen and/or silicon atoms as substituents;
R² and R³ bonded to R¹ at position 3 are, independently, hydrogen or a radical Rₐ, wherein Rₐ is a monovalent organic radical selected from C₁-C₂₀ alkyl, C₂-C₂₀ alkenyl and C₇-C₂₀ alkylaryl, said monovalent organic radical optionally containing oxygen and/or silicon atoms as substituents which are not bonded directly to the cyclopentadienyl ring moiety;
R^{2′} and R^{3′} bonded to R¹ at position 2 are, independently, hydrogen or a radical Rₐ, wherein Rₐ is as defined above;
wherein at least one of R² and R³ is Rₐ, and
   when R² is Rₐ, then R^{2′} is H, or
   when R³ is Rₐ, then R^{3′} is H, and
   when R² and R³ independently are both Rₐ, then R^{2′} and R^{3′} are simultaneously H, with the proviso that
      when R^{2′} and R^{3′} are simultaneously hydrogen, then R² and R³ are not simultaneously methyl (Me), iso-propyl (i-Pr) or tert-butyl (t-Bu) for rac isomer; or
      when R^{2′} and R^{3′} are simultaneously hydrogen, M is Zr or Hf, X¹ and X² are both Cl and Q is ═SiMe₂, then R² and R³ are not simultaneously pentenyl for rac and meso isomers;
      or when R^{2′} and R^{3′} are simultaneously hydrogen, M is Zr, X¹ and X² are both Cl and Q is ═SiMe₂, then R² and R³ are not simultaneously para-tolyl for rac and meso isomers;
   or when R² is H then R³ is not Me, or when R² is Me then R³ is not H for rac and meso isomers;
   or when R², R^{2′}, R^{3′} are H, M is Zr, X¹ and X² are both Cl and Q is ═SiMe₂, then R³is not benzyl, or when R² is benzyl, R^{2′} and R^{3′} are both H, M is Zr, X¹ and X² are both Cl and Q is ═SiMe₂, then R³ is not H for rac and meso isomers; and
X¹ and X² are, independently, monovalent ligands selected from hydrogen, halogen, C₁-C₂₀ alkyl, C₆-C₂₀ aryl, C₇-C₂₀ alkylaryl, C₇-C₂₀ arylalkyl, C₁-C₂₀ hydrocarbyloxy, C₆-C₂₀ aryloxy, C₁-C₂₀ di(alkyl)amido and carboxylate;
   its racemic or meso stereoisomers and mixtures thereof.

In accordance with another aspect of the present invention, there is provided a catalyst system comprising the bridged substituted indenyl-containing metallocenes as described above, in combination with a suitable co-catalyst or activator.

In accordance with still another aspect of the present invention, there is provided a process for producing polyethylene (co)polymers, which comprises contacting under suitable reaction conditions ethylene and optionally a higher alpha olefin with a catalyst system comprising a substituted indenyl-containing metallocene as described above in combination with a suitable co-catalyst, wherein the polyethylene produced has a polydispersity index from about 2 to about 22, and MI values from about 0 to about 50.

A preferred process for producing polyethylene (copolymers) of the present invention comprises contacting under slurry phase polymerization conditions ethylene and optionally a higher alpha-olefin with a catalyst composition comprising racemic or meso stereoisomers and mixtures thereof of above described metallocenes and a co-catalyst selected from the group consisting of methylaluminoxane and modified methylaluminoxane.

### BRIEF DESCRIPTION OF THE DRAWINGS

FIG. 1 shows a typical narrow molecular weight distribution (Type I), determined by GPC, of a polymer produced by the process provided by the instant invention by using, preferably, substantially pure isomers of selected bridged 3-indenyl-substituted metallocenes.

FIG. 2 shows a typical broad molecular weight distribution (Type II), determined by GPC, of a polymer produced by the process provided by the instant invention by using, preferably, appropriate racemic/meso mixtures of selected bridged 3-indenyl-substituted metallocenes wherein the substituent comprises a chain which is larger than ethyl.

FIG. 3 shows a typical broad bimodal molecular weight distribution (Type III), determined by GPC, of a polymer produced by the process provided by the instant invention by using, preferably, appropriate racemic/meso mixtures of selected bridged 3-indenyl-substituted metallocenes wherein the substituent comprises a short chain such as methyl or ethyl.

FIG. 4 shows a typical narrow bimodal molecular weight distribution (Type IV), determined by GPC, of a polymer produced by the process provided by the instant invention by using, preferably, appropriate racemic/meso mixtures of selected bridged 3-indenyl-substituted metallocenes.

FIG. 5 shows the ORTEP plot of meso dimethylsilanediylbis(1-indenyl-3-methyl)zirconium dichloride.

FIG. 6 shows the ORTEP plot of meso dimethylsilanediylbis(1 -indenyl-3-ethyl)zirconium dichloride.

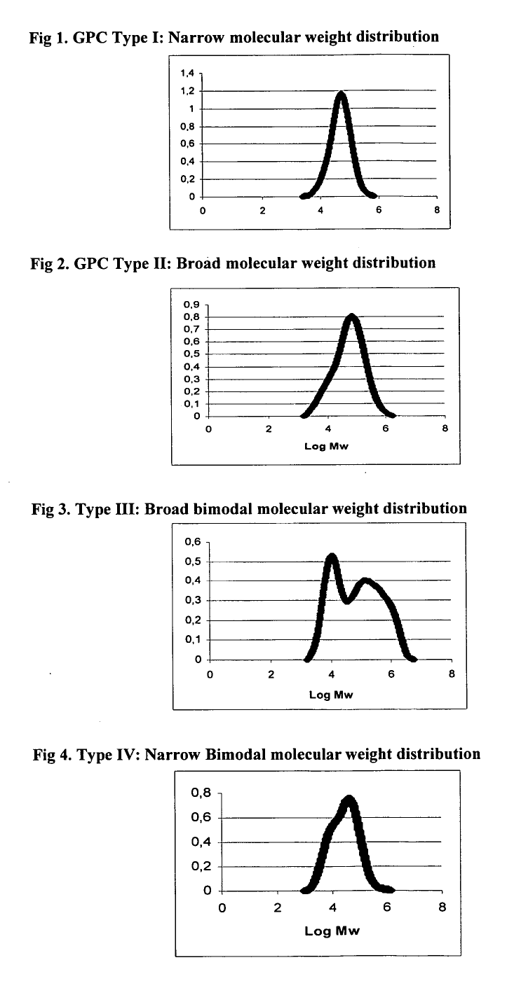

### DETAILED DESCRIPTION OF THE INVENTION

One object of the present invention relates to a bridged metallocene compound containing two substituted indenyl ligands joined by a bridging group and complexed to a metal atom of formula (I): 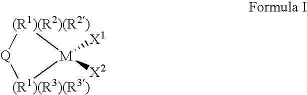
wherein:
M is a transition metal atom selected from the group consisting of the atoms of Group 4 of the Periodic Table;
R¹ is an indenyl ligand;
Q is a divalent group of formula ═SiR⁴R⁵ or —CH R⁴—CH R⁵—; wherein R⁴ and R⁵ are, independently, hydrogen atoms or monovalent radicals selected from halogen, C₁-C₂₀ alkyl, C₆-C₂₀ aryl; C₂-C₂₀ alkenyl, C₇-C₂₀ arylalkyl and C₇-C₂₀ alkylaryl, optionally containing oxygen and/or silicon atoms as substituents;
R² and R³ bonded to R¹ at position 3 are, independently, hydrogen or a radical Rₐ, wherein Rₐ is a monovalent organic radical selected from C₁-C₂₀ alkyl, C₂-C₂₀ alkenyl and C₇ -C₂₀ alkylaryl, said monovalent organic radical optionally containing oxygen and/or silicon atoms as substituents which are not bonded directly to the cyclopentadienyl ring moiety;
R^{2′} and R^{3′} bonded to R¹ at position 2 are, independently, hydrogen or a radical Rₐ,
wherein Rₐ is as defined above;
wherein at least one of R² and R³is Rₐ, and
   when R² is Rₐ, then R^{2′} is H, or
   when R³is Rₐ, then R^{3′} is H, and
   when R² and R³ independently are both Rₐ, then R^{2′} and R^{3′} are simultaneously H, with the proviso that
      when R^{2′} and R^{3′} are simultaneously hydrogen, then R² and R³ are not simultaneously methyl (Me), iso-propyl (i-Pr) or tert-butyl (t-Bu) for rac isomer; or
      when R^{2′} and R^{3′} are simultaneously hydrogen, M is Zr or Hf, X¹ and X² are both Cl and Q is ═SiMe₂, then R² and R³ are not simultaneously pentenyl for rac and meso isomers;
      or when R^{2′} and R^{3′} are simultaneously hydrogen, M is Zr, X¹ and X² are both Cl and Q is ═SiMe₂, then R² and R³ are not simultaneously para-tolyl for rac and meso isomers;
   or when R² is H then R³ is not Me, or when R² is Me then R³ is not H for rac and meso isomers;
   or when R², R^{2′}, R^{3′} are H, M is Zr, X¹ and X² are both Cl and Q is ═SiMe₂, then R³ is not benzyl, or when R² is benzyl, R^{2′} and R^{3′} are both H, M is Zr, X¹ and X² are both Cl and Q is ═SiMe₂, then R³ is not H for rac and meso isomers; and
X¹ and X² are, independently, monovalent ligands selected from hydrogen, halogen, C₁-C₂₀ alkyl, C₆-C₂₀ aryl, C₇-C₂₀ alkylaryl, C₇-C₂₀ arylalkyl, C₁-C₂₀ hydrocarbyloxy, C₆-C₂₀ aryloxy, C₁-C₂₀ di(alkyl)amido and carboxylate;
   its racemic or meso stereoisomers and mixtures thereof.

According to one embodiment of the present invention,
M is Ti, Zr or Hf,
R¹ is an indenyl ligand;
R^{2′} and R^{3′} bonded to R¹ at position 2 are both hydrogen;
R² and R³ bonded to R¹ at position 3 are, independently, selected from H or C₂-C₂₀ linear alkyl group, with the proviso that at least one of R² or R³ are C₂-C₂₀ linear alkyl group;
Q is a divalent group of formula ═SiR⁴R⁵ or —CH R⁴—CH R⁵—; wherein R⁴ and R⁵ are, independently, hydrogen atoms or monovalent radicals selected from, halogen, C₁-C₂₀ alkyl, C₆-C₂₀ aryl, C₂-C₂₀ alkenyl and C₇-C₂₀ alkylaryl optionally containing oxygen and silicon atoms as substituents;
X¹ and X² are the same or different monovalent ligands selected from the halogens.

According to a further embodiment, the compound of formula I is a rac stereoisomer. Optionally, the compound of formula I is a mixture of meso and rac stereoisomers.

The following compounds are illustrative but non-limiting examples of useful bridged metallocene catalysts containing substituted indenyl ligands:
Meso dimethylsilanediylbis(1-indenyl-3-methyl)zirconium dichloride
Rac and meso dimethylsilanediylbis(1-indenyl-3-ethyl)zirconium dichloride
Rac and meso dimethylsilanediylbis(1-indenyl-3-propyl)zirconium dichloride
Rac and meso dimethylsilanediylbis(1-indenyl-3-butyl)zirconium dichloride
Rac and meso dimethylsilanediylbis(1-indenyl-3-pentyl)zirconium dichloride
Rac and meso dimethylsilanediylbis(1-indenyl-3-hexyl)zirconium dichloride
Rac and meso 1,2 ethanediylbis(1-indenyl-3-ethyl)zirconium dichloride
Rac and meso 1,2 ethanediylbis(1-indenyl-3-propyl)zirconium dichloride
Rac and meso 1,2 ethanediylbis(1-indenyl-3-butyl)zirconium dichloride
Rac and meso 1,2 ethanediylbis(1-indenyl-3-pentyl)zirconium dichloride
Rac and meso 1,2 ethanediylbis(1 -indenyl-3-hexyl)zirconium dichloride
Rac and meso dimethylsilanediyl(1-indenyl)(1-indenyl-3-ethyl)zirconium dichloride
Rac and meso dimethylsilanediyl(1-indenyl)(1-indenyl-3-propyl)zirconium dichloride
Rac and meso dimethylsilanediyl(1-indenyl)(1-indenyl-3-butyl)zirconium dichloride
Rac and meso dimethylsilanediyl(1-indenyl)(1-indenyl-3-pentyl)zirconium dichloride
Rac and meso dimethylsilanediyl(1-indenyl)(1-indenyl-3-hexyl)zirconium dichloride
Rac and meso 1,2 ethanediyl(1-indenyl)(1-indenyl-3-methyl)zirconium dichloride
Rac and meso 1,2 ethanediyl(1-indenyl)(1-indenyl-3-ethyl)zirconium dichloride
Rac and meso 1,2 ethanediyl(1-indenyl)(1-indenyl-3-propyl)zirconium dichloride
Rac and meso 1,2 ethanediyl(1-indenyl)(1-indenyl-3-butyl)zirconium dichloride
Rac and meso 1,2 ethanediyl(1-indenyl)(1-indenyl-3-pentyl)zirconium dichloride
Rac and meso 1,2 ethanediyl(1-indenyl)(1-indenyl-3-hexyl)zirconium dichloride
Rac and meso phenylmethylsilanediyl(1-indenyl)(1-indenyl-3-methyl)zirconium dichloride
Rac and meso phenylmethylsilanediyl(1-indenyl)(1-indenyl-3-ethyl)zirconium dichloride
Rac and meso phenylmethylsilanedyil(1-indenyl)(1-indenyl-3-propyl)zirconium dichloride
Rac and meso phenylmethylsilanediyl(1-indenyl)(1-indenyl-3-butyl)zirconium dichloride
Rac and meso phenylmethylsilanediyl(1-indenyl)(1-indenyl-3-pentyl)zirconium dichloride
Rac and meso phenylmethylsilanediyl(1-indenyl)(1-indenyl-3-hexyl)zirconium dichloride
Rac and meso dimethylsilanediyl(1-indenyl-3-methyl)(1-indenyl-3-ethyl)zirconium dichloride
Rac and meso dimethylsilanediyl(1-indenyl-3-methyl)(1-indenyl-3-propyl)zirconium dichloride
Rac and meso dimethylsilanediyl(1-indenyl-3-methyl)(1-indenyl-3-butyl)zirconium dichloride
Rac and meso dimethylsilanediyl(1-indenyl-3-methyl)(1-indenyl-3-pentyl)zirconium dichloride
Rac and meso dimethylsilanediyl(1-indenyl-3-methyl)(1-indenyl-3-hexyl)zirconium dichloride
Rac and meso dimethylsilanediyl(1-indenyl-3-ethyl)(1-indenyl-3-propyl)zirconium dichloride
Rac and meso dimethylsilanediyl(1-indenyl-3-ethyl)(1-indenyl-3-butyl)zirconium dichloride
Rac and meso dimethylsilanediyl(1-indenyl-3-ethyl)(1-indenyl-3-pentyl)zirconium dichloride
Rac and meso dimethylsilanediyl(1-indenyl-3-ethyl)(1-indenyl-3-hexyl)zirconium dichloride
Rac and meso 1,2 ethanediyl(1-indenyl-3-methyl)(1-indenyl-3-ethyl)zirconium dichloride
Rac and meso 1,2 ethanediyl(1-indenyl-3-methyl)(1-indenyl-3-propyl)zirconium dichloride
Rac and meso 1,2 ethanediyl(1-indenyl-3-methyl)(1-indenyl-3-butyl)zirconium dichloride
Rac and meso 1,2 ethanediyl(1-indenyl-3-methyl)(1-indenyl-3-pentyl)zirconium dichloride
Rac and meso 1,2 ethanediyl(1-indenyl-3-methyl)(1-indenyl-3-hexyl)zirconium dichloride
Rac and meso 1,2 ethanediyl(1-indenyl-3-ethyl)(1-indenyl-3-propyl)zirconium dichloride
Rac and meso ethylenebis(1-indenyl-3-ethyl)(1-indenyl-3-butyl)zirconium dichloride
Rac and meso ethylenebis(1-indenyl-3-ethyl)(1-indenyl-3-pentyl)zirconium dichloride
Rac and meso ethylenebis(1-indenyl-3-ethyl)(1-indenyl-3-hexyl)zirconium dichloride
Rac and meso dimethylsilanediyl(1-indenyl-3-methyl)(1-indenyl-3-ethyl-4,7-dimethyl)zirconium dichloride
Rac and meso dimethylsilanediyl(1-indenyl, 3-methyl)(1-indenyl-3-propyl, 4,7-dimethyl)zirconium dichloride
Rac and meso dimethylsilanediyl(1-indenyl-3-methyl)(1-indenyl-3-butyl-4,7-dimethyl)zirconium dichloride
Rac and meso dimethylsilanediyl(1-indenyl-3-methyl)(1-indenyl-3-ethyl-4-phenyl)zirconium dichloride
Rac and meso dimethylsilanediyl(1-indenyl-3-methyl)(1-indenyl-3-propyl-4-phenyl)zirconium dichloride
Rac and meso dimethylsilanediyl(1-indenyl-3-methyl)(1-indenyl-3-butyl-4-phenyl)zirconium dichloride
Rac and meso dimethylsilanediyl(1-indenyl-3-ethyl)(1-indenyl-3-propyl-4-phenyl)zirconium dichloride
Rac and meso dimethylsilanediyl(1-indenyl-3-ethyl)(1-indenyl-3-butyl-4-phenyl)zirconium dichloride
Rac and meso dimethylsilanediyl (1-indenyl-3-ethyl)(1-indenyl-3-propyl-4,7-dimethyl)zirconium dichloride
Rac and meso dimethylsilanediyl(1-indenyl-3-ethyl)(1-indenyl-3-butyl-4,7-dimethyl)zirconium dichloride
Rac and meso dimethylsilanediyl(1-indenyl-2-methyl)(1-indenyl-3-methyl)zirconium dichloride
Rac and meso dimethylsilanediyl(1-indenyl-2-methyl)(1-indenyl-3-ethyl)zirconium dichloride
Rac and meso dimethylsilanediyl(1-indenyl-2-methyl)(1-indenyl-3-propyl)zirconium dichloride.
Rac and meso dimethylsilanediyl(1-indenyl-2-ethyl)(1-indenyl-3-ethyl)zirconium dichloride
Rac and meso dimethylsilanediyl(1-indenyl-2-ethyl)(1-indenyl-3-propyl)zirconium dichloride
Rac and meso 1,2 ethanediyl(1-indenyl-2-methyl)(1-indenyl-3-propyl)zirconium dichloride.
Rac and meso 1,2 ethanediyl(1-indenyl-2-ethyl)(1-indenyl-3-ethyl)zirconium dichloride
Rac and meso 1,2 ethanediyl(1-indenyl-2-ethyl)(1-indenyl-3-propyl)zirconium dichloride.

In a preferred embodiment the invention relates to a racemic stereoisomer of the bridged metallocene compound described above wherein the stereoisomer is represented by formula (II): 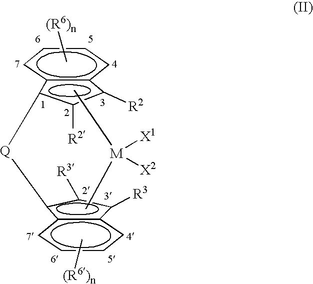
wherein:
M, R², R³, R^{2′}, R^{3′}, Q, X¹ and X² are those defined above;
R⁶ and R⁶′ are independently methyl or phenyl; and
n and n′ are independently 0, 1 or 2, with n and n′ preferably being 0,
R² and R³ are preferably selected from the group formed by hydrogen, methyl, ethyl, propyl, butyl and hexyl, and
Q is preferably a phenylmethylsilanediyl group, a dimethylsilanediyl group or an ethanediyl group.

In another preferred embodiment, the invention relates to a meso stereoisomer of the bridge metallocene described above wherein the stereoisomer is represented by formula III: 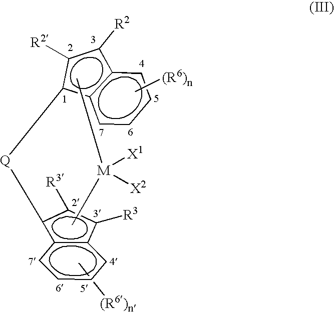
wherein:
M, R², R³, R^{2′}, R^{3′}, Q, X¹ and X² are those defined above;
R⁶ and R⁶′ are, independently, methyl or phenyl; and
n and n′ are, independently, 0, 1 or 2, with n and n′ preferably being 0,
R² and R³ are preferably selected from the group formed by hydrogen, methyl, ethyl, propyl, butyl and hexyl, and
Q is preferably a phenylmethylsilanediyl group, a dimethylsilanediyl group or an ethanediyl group.

For the purpose of this invention by the use of pure racemic or meso stereoisomers regarding polymerization is meant the utilization of substantially pure samples of corresponding isomer containing from about 0 to about 10 percent molar proportion of the other isomer.

In a still another preferred embodiment, the invention relates to a composition comprising a mixture of both a racemic and a meso stereoisomer represented by formulae (IIa) and (IIIa) respectively: 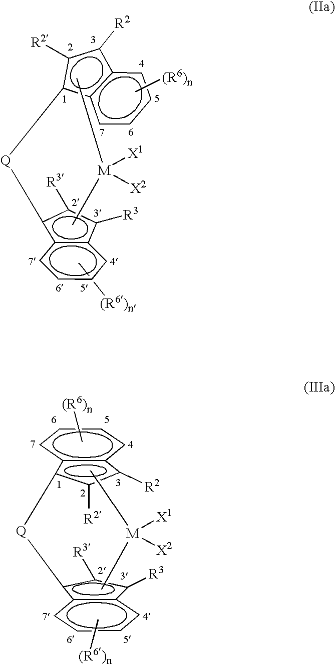
wherein:
M, Q, X¹ and X² are those defined hereinabove;
R² and R³ bonded to the indenyl ligand at position 3 are, independently, hydrogen or a radical Rₐ, wherein Rₐ is a monovalent organic radical selected from C₁-C₂₀ alkyl, C₂-C₂₀ alkenyl, and C₇-C₂₀ alkylaryl, said monovalent organic radical optionally containing oxygen and/or silicon atoms as substituents which are not bonded directly to the cyclopentadienyl ring moiety;
R^{2′} and R^{3′} bonded to the indenyl ligand at position 2 are, independently, hydrogen or a radical Rₐ, wherein Rₐ is as defined above;
wherein at least one of R² and R³ is Rₐ, and
   when R² is Rₐ, then R^{2′} is H,
   when R³ is Rₐ, then R^{3′} is H, and
   when R² and R³ independently are Rₐ, then R^{2′} and R^{3′} are simultaneously H;
R⁶ and R⁶′ are, independently, methyl or phenyl; and
n and n′ are, independently, 0, 1 or 2, with n and n′ preferably being 0.
R² and R³ are preferably selected from the group formed by hydrogen, methyl, ethyl, propyl, butyl and hexyl, and
Q is preferably a phenylmethylsilanediyl group, a dimethylsilanediyl group or an ethanediyl group.

The inventive metallocenes can be prepared by one or several methods. The method of preparation is not critical. One method comprises first reacting two equivalents of a substituted indene (see for example T. E. Ready, J. C. W. Chien and M. D. Rausch J. Organomet. Chem. 583 (1999) 11-27) with a metallic deprotonating agent such as an alkyllithium or potassium hydride in an organic solvent such as diethylether or tetrahydrofuran followed by reaction of this metallated indene with a solution of a doubly-halogenated compound such as for example dichlorodimethylsilane or 1,2 dibromo ethane. The resulting ligand is then isolated by known methods to those skilled in the art (distillation, chromatography) or it can be used as it is obtained if found of practical purity. Alternatively the ligand can be made by making first non-substituted silicon-bridged indenyl such as dimethylsilylbisindene or 1-2 ethylenebisindene compounds well known in the art, and then reacting with two equivalents of deprotonating reagent to obtain its dilithium or dipotasium salt. The optionally desired substituted ligand is obtained after reaction of the dimetallic salt of the non-substituted bridged ligands with two equivalents of suitable alkylhalide.

The isolated bridged substituted-indenyl ligand is again reacted with two equivalents of a metallic deprotonating reagent and then reacted with one mole of titanium tetrachloride, zirconium tetrachloride or hafnium or some suitable aduct with ethers like diethyl ether tetrahydrofurane and the like. The resulting bridged metallocene can be recovered and purified using conventional techniques known in the art including filtration, extraction, crystallization and recrystallization.

Another aspect of the present invention relates to a polymerization catalyst system comprising at least one metallocene or a composition as described above in combination with one or more suitable co-catalyst. Preferred co-catalyst include generally any of those types of compounds which are known in the art as suitable to be employed in conjunction with transition metallocene-type olefin polymerization catalysts including aluminoxanes, modified aluminoxanes, and non-coordinating anions. It is within the scope of this invention to use aluminoxane or modified aluminoxane as co-catalyst and/or also ionizing activators, neutral or ionic such as tetrakis(pentafluorophenyl) boron salts or tris(pentafluorophenyl) boron metalloid precursors.

The currently most preferred co-catalyst or activator (both words being used in this disclosure synonymously) is methylaluminoxane (MAO) or modified methylaluminoxane (MMAO). Aluminoxanes are well known in the art and comprise oligomeric linear or cyclic alkyl compounds having respectively the formula:

R—(AlR—O)ₓ—AlR₂ for linear and (—AlR—O)ₙ for cyclic, where R is methyl group. For modified methylaluminoxane, R is a mix of methyl and larger alkyl groups from 2 to 12 carbon atoms.

Aluminoxanes can be prepared by a variety of methods, non-limiting examples being disclosed for example in EP-A-0561476, EP-B1-0 279586, EP-A-0 594 218, U.S. Pat. No. 4,665,208, EP 0372483 and EP0403830. Modified methylaluminoxanes which contain both methyl groups and higher alkyl groups can be synthesized as disclosed in, for example, U.S. Pat. No. 5,041,584.

The mole ratio of aluminum atoms contained in the MAO or MMAO to metal atoms contained in the bridged metallocene catalyst is generally in the range of 1:1 to about 100,000:1, more preferably from 5:1 to 10,000:1 and most preferably in the range of 20:1 to 2,000:1.

The substituted indenyl-containing metallocenes when used in combination with aluminoxanes are particularly useful for the polymerization of C₂-C₂₀ alpha-olefins or for the copolymerization of ethylene and C₃-C₂₀ alpha-olefins. Examples of such olefins include propylene, 1-butene, 1-pentene, 1-hexene, 1-octene and mixtures thereof.

The polymerizations can be carried out under a wide range of conditions. The temperatures may be in the range from 20 to about 250 degrees C., preferably from 50 degrees C. to about 200 degrees C. and the pressures employed may be in the range from 1 atmosphere to about 1000 atmospheres or higher.

Such polymerizations could be carried out in a homogeneous system in which the catalyst and co-catalysts are soluble, however in a preferred embodiment the polymerization is carried out in the presence of supported or insoluble particulate form of the catalyst and/or co-catalyst.

By support or carrier is meant any solid, preferably a porous inorganic material, for example inorganic oxides or inorganic chlorides. Other carriers could include polymeric support materials such as polystyrene divinylbenzene polymeric compounds.

As preferred supports silica, alumina, silica-alumina, aluminophosphates and magnesium chloride may be used, but other materials like silica-chromium, silica-titania and clay minerals may also be useful as well.

Most preferred as a carrier is an inorganic oxide having a surface area in the range of from about 15 to about 600 m²/g, pore volume in the range of from about 0.1 to about 3,5 cc/g and average particle size in the range of from about 5 to about 300 microns. More preferably, the surface area of the carrier is in the range of from about 50 to about 500 m²/g, pore volume in the range of from about 0.5 to about 3,5 cc/g, and average particle size in the range of from about 5 to about 100 microns.

There are many examples and methods known in the art for supporting the metallocene-type catalyst systems of the invention such as those disclosed in for example U.S. Pat. No. 4,701,432; U.S. Pat. No. 4,808,561; U.S. Pat. No. 5,240,894; and U.S. Pat. No. 5,332,706.

Supported catalyst prepared with the metallocene compounds provided in the present invention can be made by several methods, such as addition of a solution of said metallocenes in a suitable non-polar solvent as toluene on a solid support containing the co-catalyst previously supported on an inorganic oxide or alternatively by addition of a mixture of the metallocene and co-catalyst directly to a dehydrated inorganic oxide carrier or combination of both by depositing the mixture of metallocene and the co-catalyst on a solid support containing additional co-catalyst previously supported on the inorganic oxide carrier. In all cases after suitable contact time of any solution and any solid component, solvent is eliminated usually under partial vacuum until a free-flowing powder is finally obtained.

In one preferred method for producing the supported metallocene catalyst system of the invention, such as described in the non-limiting examples below, a solution containing the activator is added to a solution or slurry of the metallocene. Most preferred solvents are aromatic solvents such as toluene but other cyclic aliphatic or isoaliphatic solvents may be also used when capable of maintaining the mixture under solution.

The activator-metallocene mixture where the mole ratio of the aluminum contained in the co-catalyst to the metal is in the range of between 3:1 to 1000:1, preferably 20:1 to 700:1 and most preferably 50:1 to 400:1 is made to react first and then added to a porous support to from a slurry or a thick mixture and stirred preferably during enough time allowing for the solution and its components to diffuse into the pores of the solid carrier. Finally solvent is evaporated to yield a free-flowing powder. Optionally heat may be applied during stirring or mixing of the solid-liquid mixture described above or during stripping of the solvent.

The catalysts and catalysts systems of the present invention are suitable for use in any polymerization process over a wide range of temperatures and pressures. Polymerization processes include solution, gas phase, slurry phase and a high pressure process. Particularly preferred is a slurry phase or gas phase polymerization of one or more olefins including at least ethylene or propylene.

In the most preferred embodiment of the process of the invention, a copolymer of ethylene is produced, where ethylene is polymerized with a co-monomer having at least one alpha olefin having from 4 to 12 carbon atoms, more preferably from 4 to 8 carbon atoms in a slurry process.

It is within the scope of the invention to use a mixture of two or more metallocenes in turn in the form of substantially pure isomers or mixtures thereof (rac and meso isomers).

A particularly preferred process is slurry or gas phase polymerization of one or more olefins at least one of which is ethylene or propylene.

In the most preferred embodiment of the process of the invention, a copolymer of ethylene is produced by copolymerization of ethylene with a co-monomer having at least one alpha-olefin having from 4 to 12 carbon atoms, and most preferably from 4 to 8 carbon atoms.

In a slurry polymerization, a suspension of solid, particulate polymer is formed in a liquid polymerization diluent including propane, butane, isobutane, pentane, hexane, heptane and the like to which ethylene and co-monomer and optionally hydrogen along with catalyst are added.

The suspension including diluent is intermittently removed from the reactor where volatile components are separated from the polymer and recycled optionally after separation to the reactor.

In a preferred polymerization technique of the invention the catalyst is added in solid form in such a way referred to as particle form polymerization and the temperature is kept below the temperature at which the polymer goes into solution, therefore the polymer is maintained under slurry phase. Such technique is well known in the state of art and disclosed for example in U.S. Pat. No.3,248,179. Typical slurry processes include those employing a loop reactor and those utilizing several stirred reactor in series, parallel or combination thereof such as continuous loop or stirred tank process.

The polymers produced with this invention have a wide range of uses that will be apparent to those skilled in the art.

The polymers produced by the process of the invention, typically ethylene-based polymers, have a wide variety of molecular weight distribution, including:

Type I: Narrow, with Mw/Mn from around 1,9 to about 3,5 preferably obtained with substantially pure isomers like shown in FIG. 2.

Type II: Broad with Mw/Mn greater than 2 to about 8 more preferably from 2.5 to about 8 more preferably from about 3 to about 5 preferably obtained with appropriate racemic/meso mixtures of selected metallocenes with longer than ethyl chain substituent shown in FIG. 3.

Type III: Bimodal with high polydispersity index with values of Mw/Mn form about 10 to about 25 like shown in FIG. 4 preferably obtained with appropriate racemic/meso mixtures of selected metallocenes preferably with short chain substituent such as methyl or ethyl.

Type IV: Bimodal with low polydispersity index with values of Mw/Mn form about 2,5 to about 5 like shown in FIG. 5. Preferably obtained with rac and meso mixtures of mono-substituted metallocenes.

The polymers of the present invention in one embodiment have a melt index (MI) or I₂ as measured by ASTM-D-1238-E in the range from about 0.01 to 400 g/10 min, more preferably from about 0.01 to about 100 g/10 min even more preferably from about 0.1 g/10 min to about 40 g/10 min and most preferably from about 0.1 dg/min to 25 g/10 min.

The polymers of the invention in one embodiment have a melt index ratio (I₂₁/I₂) from about 15 to less than 25 (for I₂₁ measured by ASTM-D-1238-F). In another embodiment the polymers have a melt index ratio of from preferable greater than 25 to about greater than 60.

### EXAMPLES

For a further understanding of the present invention, its various aspects and advantages the following examples are provided.

Preparation of the metallocenes and all of others operations handling them and also co-catalyst in polymerization operations were carried out routinely using Schlenk techniques and performing some particular sensitive operations inside a dry box, in every case with strict exclusion of air and moisture by means of dried inert gas and using solvents dried over molecular sieve.

Size exclusion Chromatography (SEC) measurements were performed at 145° C. in a Waters 150C equipment, with solvent 1,2,4 TCB and 0.04 wt.—% of Irganox 1010 as stabilizer. A set of PL gel columns (10⁶, 2× mixed bed 10 microns) was used. Operating conditions were as follows: flow rate 0.7 mL/min, sample concentration 5 mg/mL, and injection volume 500 microL. Twelve samples of polystyrene with narrow molecular weights (ranging from 1800 to 2300000) were used as standards, considering the elution volume at the peak representative of the sample. A differential refractive index (DRI) detector and a differential viscometer Viscotek 150, working at 145° C., were coupled on line at the end of the columns. A validation of the calibration curve is made using internal standards and other standard (NIST 1475, Mw: 53070 and broad polidispersity).

Flow index (FI) is reported as grams per 10 minutes and is determined in accordance with ASTM D-1238, condition F, and is measured at ten times the weight used in the melt index.

Melt indexes (MI) are reported as grams per 10 minutes, determined in accordance with ASTM D-1238 condition E at 190 degree C.

MFR is the melt flow ratio, which is the ratio of flow index to melt index and is related with molecular weight distribution.

### EXAMPLES

### A. Preparation of Disubstituted Symmetric Ligands [Me₂Si(3-R—C₉H₆)₂]R═CH₃ (1), CH₂CH₃ (2), CH₂CH₂CH₃ (3), CH₂CH₂CH₂CH₃ (4), CH₂C₆H₅ (5) [(3-R—C₉H6)—CH₂—CH₂-(3-R—C₉H₆) R═CH₂CH₃ (6) CH₂CH₂CH₃ (7)

General Procedure:

(1): To a solution of (C₉H₈) (6.00 g, 51.65 mmol) in Et₂O, n-BuLi in hexane is added dropwise (1.60 M) (38.74 ml, 61.98 mmol) at −78° C.

After addition is finished temperature is allowed to rise and stirring is continued for an additional 4 hours period at room temperature. Temperature is lowered again at −78° C. and SiMe₂Cl₂ (3.33 g, 25.83 mmol), is dropwise added. Resulting suspension is maintained for 15 hours under stirring allowing the temperature to raise at the end of addition until room temperature is reached. Solvent is stripped of under low pressure and the residue extracted with hexane (2×50 ml) yielding [Me₂Si(C₉H₆)₂] (7.37 g, 98%) as a yellow oil.

[Me₂Si(C₉H₆)₂] (7.37 g, 25.55 mmol) is solved in Et₂O, n-BuLi (1.60 M in hexane) (38.33 ml, 61.33 mmol) is added dropwise at low temperature (−78° C.). When addition is finished temperature is allowed to raise until room temperature and reaction mixture maintained under stirring for an additional 4 hour period. CH₃I (14.50 g, 102.20 mmol), is dropwise added over at −78° C., and stirring maintained after addition is finished for 15 more hours at room temperature. Solvent and other volatile components are stripped off under vacuum and the residue extracted with hexane. The desired compound is obtained after elimination of solvent as a yellow oil (7.11 g, 88%).

Ligands (2), (3), (4) and (5)

Preparation of ligands: (2), (3) and (4) and (5) was carried out similarly to the preparation of ligand (1) described above from the dilithium salt of [Me₂Si(C₉H₆)₂] and an excess (40% over stoichiometric) of corresponding ethyl, propyl, butyl bromide. Ligands were finally isolated as yellow oils in aproximately 85% yields.

### Ligands (6) and (7): [(3-R—C₉H₆)—CH₂—CH-(3-R—C₉H₆)—]R═CH₂CH₃ (6) CH₂CH₂CH₂CH₃ (7)

C₉H₇—CH₂CH₃ and C₉H₇—CH₂CH₂CH₃ were prepared first by a similar method as that described in T. E. Ready .et al., J. Organometallic Chemistry 519(1996) 21-28 as follows:

To a solution of (C₉H₈) (30 g, 0,258 mmol) in 150 ml diethylether n-BuLi (1.60M in hexane) (193.7 ml, 0.31 mmol) is dropwise added at −78° C. under stirring. After the addition was completed, the mixture was allowed to warm to room temperature and stirring maintained for an aditional 4 hour period. After cooling again at −78° C. Ethylbromide or n-Propyl bromide (31 mmol) respectively is dropwise added, temperature was allowed to raise after addition was finished and stirring maintained 15 more hour at room temperature. Stripping off the solvent under reduced pressure and extraction of the residue with 100 ml hexane yields the desired 3-R—C₉H₇ after final solvent removal (80% yield).

Final purification was made by distillation, recovering the fraction distilled at 60-70° C. at 3 mbar for C₉H₇—CH₂CH₃ and 60° C. at 1 mbar for C₉H₇—CH₂CH₂CH₃.

Corresponding bridging ligands were next prepared as follows:

Over a cold ether/THF solution (100 ml/20 ml) of C₉H₇—CH₂CH₂CH₂CH₃ (34 g, 0.2 mols) and C₉H₇—CH₂CH₃ (29 g; 0.2 mols) maintained at −10° C. 80 ml of 2.5M nBuLi in hexane is dropwise added for a 30 minutes period while stirring. After addition was finished the reaction mixture was stirred 4 more hours. The resulting solution was added slowly to a 50 ml Et₂O solution of dibromoethane (19 g)) kept at 0° C. After addition was finished (over 30 minutes), temperature was allowed to rise and the reaction mixture stirred at room temperature for 15 hours.

The reaction mixture was quenched by addition of 200 ml of deionized water. Organic phase was separated and dried over MgSO₄. The final products (6) and (7) respectively were obtained after filtration and solvent removal and finally elimination of other volatile components at 90° C. at 1 mbar as a viscous clear yellow oil solidifying upon cooling with 75% yield.

### B. Preparation of Monosubstituted Ligands: [Me₂Si(3-R—C₉H₆)(C₉H₇)]:CH₂CH₃ (8), CH₂CH₂CH₃ (9)

C₉H₇—CH₂CH₂CH₃ was prepared first by a similar method as that described previously for the ethyl and butyl indenes.

To a solution of (3-R—C₉H₇)R═CH₂CH₃; CH₂CH₂CH₃ (21.61 mmol) in Et₂O (100 ml) kept at −78° C., nBuLi (1.60 M en hexano) (16.21 ml, 25.93 mmol) was dropwise added ,after addition is finished temperature was slowly raised to room temperature and stirring maintained for an aditional 4 hour period. The resulting suspension was slowly added to a solution of SiMe₂Cl₂ (14.00 g, 108.05 mmol) in Et₂O (25 ml), at −78° C. Temperature was allowed to raise after addition was finished and stirring maintained 15 more hour at room temperature. Stripping off the solvent under reduced pressure and extraction of the residue with hexane (100 ml) yields the corresponding chlorosilylderivatives [ClMe₂Si(3-R—C₉H₆)]R═CH₂CH₃; CH₂CH₂CH₃ (yield 92%).

A solution of [Li(C₉H₇)] (2.43 g, 19.93 mmol) in Et₂O (100 ml) is dropwise added over a cooled (−78° C.) solution of [ClMe₂Si(3-R—C₉H₆)]R═CH₂CH₃; CH₂CH₂CH₃ (19.93 mmol) in Et₂O (50 ml). Temperature was allowed to raise after addition was finished and stirring maintained 15 more hour at room temperature. The reaction mixture was quenched by addition of 100 ml of deionized water Organic phase was separated and dried over MgSO₄. The final products (8) and (9) respectively were obtained after filtration and solvent removal as a viscuous clear yellow oil in 78% yield.

### C. Preparation of Non Symmetric Disubstituted Ligands [Me₂Si(3-R′—C₉H₆)(3-R″—C₉H₆)] (10) R′═CH₂CH₃, R″═CH₂CH₂CH₃

[ClMe₂Si(3-R—C₉H₆)]R═CH₂CH₂CH₃ was made first as in B and isolated as a yellow oil:

¹H NMR(CDCl₃): delta 0.251(s,3H,MeSi), 0.256(s,3H,MeSi), 1.081(t,3H,CH₃—CH₂),1.788(m,2H,CH₃—CH₂—), 2.664(t,2H,CH₃CH₂CH₂), 3.690(brs,1H,HC₅ ring), 6.368(s,1H,H,C₅ring), 7.282(m,1H,H C₆ring), 7.370(m,1H,H C₆ ring), 7.490(d,1H,H C₆ring), 7.615(d,1H,H,C₆ ring).

Ligand (10) was made in a similar manner as to ligand (9) except a solution of [Li(C₉H₆—CH₂CH₃)] was added instead of [Li(C₉H₇)], a yellow oil was recovered as a mixture of isomers rac/meso.

¹H NMR(CDCl₃): delta −0.44(s,3H,mMeSi), −0.24(s,3H,rMeSi), −0.22(s,3H,MeSi), −0.02(s,3H,mMeSi), 1.07(m,3H,CH₃CH₂CH₂), 1.33,1.37(t,t,3H,CH₃CH₂—), 1.78(m,2H,CH₃CH₂CH₂), 2.68(m,2H+2H,CH₃CH₂CH₂—,CH₃CH₂—), 3.54(brs,2H,H¹ ring), 6.13,6.17,6.30,6.34 (s,1H,H² ring), 7.22,7.35,7.48 3(m,8H,H⁵,H⁸,H⁶H⁷ ring).

### Example 1

### Preparation of Meso-[Zr{Me₂Si(3-CH₃-(η⁵-C₉H₅))₂}Cl₂]R═CH₃ (11)

[Me₂Si(3-CH₃—C₉H₆)₂] (5.00 g, 15.80 mmol) was disolved in Et₂O (100 ml) and nBuLi (1.60 M in hexane) (23.70 ml, 37.92 mmol), was dropwise added at −78° C. under stirring. After the addition was completed temperature was slowly raised until room temperature was reached and the reaction mixture mantained under stirring during 4 hours more yielding a yellow suspension of the dilithium salt. To a −20° C. sitirred and cooled ZrCl₄ suspension in toluene (3.69 g, 15.80 mmol) (50 ml toluene), the dilithium salt suspension previously prepared was portionwise added and temperature kept after addition is finished during 30 minutes. Temperature was allowed to raise to room temperature and the reaction mixture stirred for 15 additional hour. A yellow-brown suspension is finally obtained. All solvents were removed in vacuo and CH₂Cl₂ (300 ml) added to the residue, the suspension formed is filtered through dry Celite and the filtrate was concentrated in vacuo to dryness. The solid was washed with hexane (100 ml) and ethyl ether (100 ml), and the bright orange residue identified by its ¹HNMR spectrum as a mixture of rac and meso isomers. The separation of the two isomers was achieved by repeated fractional recrystallization at low temperature in toluene.

Four samples were prepared for testing with different stereoisomeric racemic:meso proportion of 5:95;13:87;20:80 and 53:47 (rac:meso molar proportion)

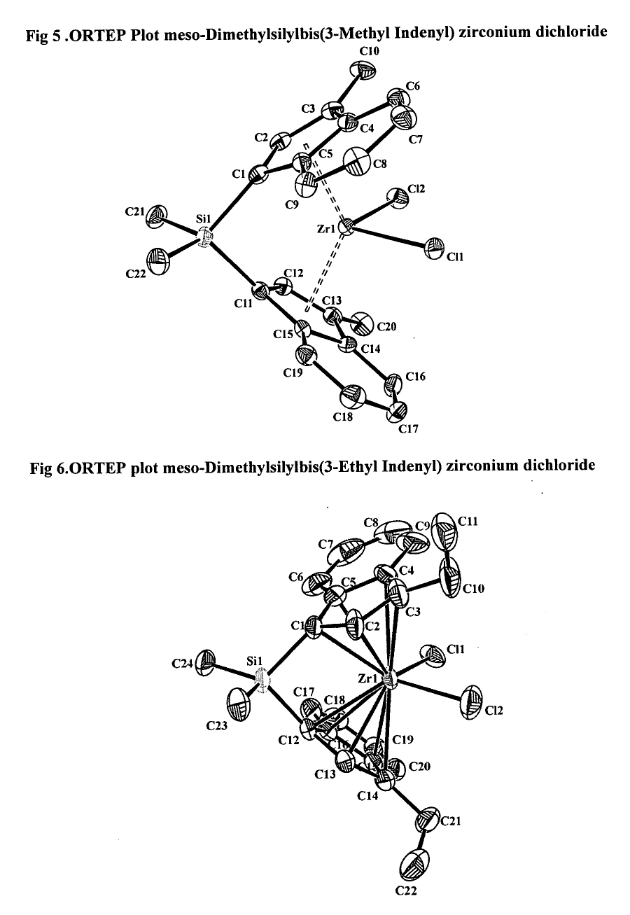

The meso isomer (6:94) was obtained in 15% yield. Suitable crystals were separated and its crystal structure solved by X-Ray diffraction: ORTEP diagram is shown in FIG. 6.

### Example 2

### Preparation of Rac and Meso Isomers of [Zr{Me₂Si(3-CH₃CH₂-(η⁵-C₉H₅))₂}Cl₂] (12)

Synthesis of compound (12) was carried out in a similar manner as that of (11) using the following reagents: [Me₂Si(3-R—C₉H₆)₂]R═CH₂CH₃ (5.00 g, 14.03 mmol), nBuLi (1.60 M in hexane) (21.05 ml, 33.67 mmol) and ZrCl₄ (3.27 g, 14.03 mmol). Yield (30%).

Compound (12) was isolated as a mixture of racemic and meso isomer and being identified by their ¹HNMR spectra.

Two samples with different proportion of isomeric rac:meso proportions were isolated: 9:91 and 50:50.

| δ(ppm) Meso isomer | δ(ppm) Rac isomer | H |
|---|---|---|
| | 1.10(s, 6H) | Si(CH₃)₂ |
| 0.91(s, 3H) | | Si(CH₃) (exo) |
| 1.36(s, 3H) | | Si(CH₃) (endo) |
| 1.21(t, 6H) | 1.11(t, 6H) | —CH₂CH₃ |
| 2.80(m, 4H) | 2.75(m, 4H) | —CH₂CH₃ |
| 5.62(s, 2H) | 5.82(s, 2H) | H² indene ring |
| 6.92, 7.18(dd, 1H) | 7.05, 7.31(dd, 2H) | H⁵, H⁶ indene ring |
| 7.45, 7.48(d, 1H) | 7.45, 7.48(d, 2H) | H⁴, H⁷ indene ring |

Suitable crystals of the meso isomer were grown and the crystal structure determined by X Ray difraction. ORTEP diagram is shown in FIG. 6.

### Example 3

### Preparation of Rac/Meso [Zr{Me₂Si(3-CH₃CH₂CH₂-(η⁵-C₉H₅))₂}Cl₂] (13)

Synthesis of compound (13) as a rac/meso mixture of stereoisomers was carried out in a similar manner as that of (12) using the following reagents: [Me₂Si(3-R—C₉H₆)₂]R═CH₂CH₂CH₃ (5.00 g, 14.03 mmol), nBuLi (1.60 M in hexane) (21.05 ml, 33.67 mmol) and ZrCl₄ (3.27 g, 14.03 mmol). From the yellow-brown suspension obtained after reaction was completed ethyl ether was removed in vacuo the toluene solution was filtered trough Celite and the retained residue washed with additional toluene (250 ml). Evaporation of toluene from the filtrate yields an orange crystalline solid identified as a mixture of rac and meso isomers of (11) (26% yield) by ¹HNMR analysis. Desired compound was isolated as a 59:41 rac:meso mixture.

| δ(ppm) Meso isomer | δ(ppm) Rac isomer | H |
|---|---|---|
| | 1.25(s, 6H) | Si(CH₃)₂ |
| 1.04(s, 3H) | | Si(CH₃) (exo) |
| 1.51(s, 3H) | | Si(CH₃) (endo) |
| 1.03(t, 6H) | 1.07(t, 6H) | —CH₂CH₂CH₃ |
| 1.74(m, 4H) | 1.65(m, 4H) | —CH₂CH₂CH₃ |
| 2.98(m, 4H) | 2.84(m, 4H) | —CH₂CH₂CH₃ |
| 5.73(s, 2H) | 5.81(s, 2H) | H² ring |
| 7.07, 7.32(dd, 1H) | 7.19, 7.47(dd, 2H) | H⁵, H⁶ ring |
| 7.57, 7.65(d, 1H) | 7.57, 7.65(d, 2H) | H⁴, H⁷ ring |

### Example 4

### Preparation of Rac/Meso [Zr{Me₂Si(3-nBu-(η⁵-C₉H₅))₂}Cl₂] (14)

Synthesis of compound (14) was carried out in a similar manner as (13) using as reagents: [Me₂Si(3-R—C₉H₆)₂]R═CH₂CH₂CH₂CH₃ (5.00 g, 12.48 mmol), nBuLi (1.60 M en hexano) (18.72 ml, 29.95 mmol) and ZrCl₄ (2.91 g, 12.48 mmol).

The desired compound was obtained as an orange solid (35% yield) as a mixture of rac/meso 58:42 isomers and identified by ¹HNMR analysis.

| δ(ppm) Meso isomer | δ(ppm) Rac isomer | H |
|---|---|---|
| 0.87(s, 3H) | | Si(CH₃) (exo) |
| 0.89(t, 6H) | 0.90(t, 6H) | —CH₂CH₂CH₂CH₃ |
| | 1.11(s, 6H) | Si(CH₃)₂ |
| 1.36(s, 3H) | | Si(CH₃) (endo) |
| 1.34(m, 4H) | 1.34(m, 4H) | —CH₂CH₂CH₂CH₃ |
| 1.51(m, 4H) | 1.51(m, 4H) | —CH₂CH₂CH₂CH₃ |
| 2.72(m, 4H) | 2.82(m, 4H) | —CH₂CH₂CH₂CH₃ |
| 5.58(s, 2H) | 5.77(s, 2H) | H² ring |
| 6.91, 7.16(dd, 1H) | 7.06, 7.32(dd, 1H) | H⁵, H⁶ ring |
| 7.41, 7.49(d, 1H) | 7.41, 7.49(d, 1H) | H⁴, H⁷ ring |

### Example 5

### Preparation of Rac/Meso Isomers of [Zr{Me₂Si(3-CH₂C₆H₅-(η⁵-C₉H₅))₂}Cl₂] (15)

Synthesis of compound (15) was carried out in a similar manner as (12) using as reagents [Me₂Si(3-R—C₉H₆)₂]R═CH₂Ph (5.00 g, 10.67 mmol), nBuLi (1.60 M in hexane) (16.00 ml, 25.61 mmol) y ZrCl₄ (2.49 g, 10.67 mmol).

The desired compound was obtained as an orange solid (40% yield) as a mixture of rac/meso isomers and identified by ¹HNMR analysis.

| δ(ppm) Meso isomer | δ(ppm) Rac isomer | H |
|---|---|---|
| | 0.79(s, 6H) | Si(CH₃)₂ |
| 1.01(s, 3H) | | Si(CH₃) (exo) |
| 1.29(s, 3H) | | Si(CH₃) (endo) |
| 4.28(dd, 4H) | 4.12(dd, 4H) | —CH₂C₆H₅ |
| 5.77(s, 2H) | 5.59(s, 2H) | H² |
| 7.02-7.48(m, 10H) | 7.02-7.48(m, 10H) | —CH₂C₆H₅ |
| 7.02-7.48(m, 8H) | 7.02-7.48(m, 8H) | H⁴ to H⁷ ring |

### Example 6

### Preparation of Rac and Meso Isomers of [Zr{Me₂Si(3-R-(η⁵-C₉H₅)(η⁵-C₉H₆}Cl₂]R═CH₂CH₂CH₃ (16)

Synthesis of compound (16) was carried out in a similar manner as (12) using as reagents. [Me₂Si(3-R—C₉H₅)(C₉H₆)]R═CH₂CH₂CH₃ (5.04 g, 15.25 mmol), nBuLi (1.60 M in hexane) (22.88 ml, 36.60 mmol) and ZrCl₄ (3.55 g, 15.25 mmol).

The desired compound was obtained as an orange solid (40% yield) shown to be a mixture of rac/meso isomers and identified by ¹HNMR analysis.

The separation of the two isomers was achieved by repeated fractional recrystallization from cold toluene (−30° C.).

Three samples were isolated as rac (99:1 rac/meso) meso (1:99) and mixture of rac/meso 38:62.

| δ(ppm) Meso isomer | δ(ppm) Rac isomer | H |
|---|---|---|
| 0.94(s, 3H), 1.38(s, 3H) | 1.12(s, 3H), 1.14(s, 3H) | Si(CH₃)₂ |
| 0.95(t, 3H) | 0.89(t, 3H) | —CH₂CH₂CH₃ |
| 1.63(m, 2H) | 1.51(m, 2H) | —CH₂CH₂CH₃ |
| 2.82(m, 2H) | 2.69(m, 2H) | —CH₂CH₂CH₃ |
| 5.71(s, 1H) | 5.76(s, 1H) | H² ring |
| 5.98(m, 1H) | 6.12(m, 1H) | H^{2′} ring |
| 7.05(m, 1H) | 6.92(m, 1H) | H^{3′} ring |
| 6.94(m, 2H), 7.21(m, 2H), | 7.08(m, 2H), 7.35(m, 2H), | H⁴ to H⁷, |
| 7.43(m, 1H), 7.50(m, 1H), | 7.46(m, 2H), 7.49(m, 1H), | H^{4′} to H^{7′} ring |
| 7.57(m, 2H) | 7.62(m, 1H) | |

### Example 7

### Preparation of Rac and Meso Isomers of [Zr{Me₂Si(3-R-(η⁵-C₉H₅)(η⁵-C₉H₆}Cl₂]R═CH₂CH₃ (17)

The desired compound was obtained as an orange solid (30% yield) shown to be a mixture of rac/meso isomers and identified by ¹HNMR analysis.

The separation of the two isomers was achieved by repeated fractional recrystallization from cold toluene (−30° C.).

Three samples were isolated as rac (98:2 rac/meso), meso (2:98 rac/meso) and mixture of isomers rac/meso 55:45.

¹HRMN:

| δ(ppm) Meso isomer | δ(ppm) Rac isomer | H |
|---|---|---|
| 0.94(s, 3H), 1.36(s, 3H) | 1.14(s, 6H) | Si(CH₃)₂ |
| 1.22(t, 3H) | 1.12(t, 3H) | —CH₂CH₃ |
| 2.86(c, 2H) | 2.77(m, 2H) | —CH₂CH₃ |
| 5.72(s, 1H) | 5.81(s, 1H) | H² ring |
| 5.97(m, 1H) | 6.13(m, 1H) | H^{2′} ring |
| 7.04(m, 1H) | 6.92(m, 1H) | H^{3′} ring |
| 6.93(m, 2H), 7.20(m, 2H), | 7.09(m, 2H), 7.35(m, 2H), | H⁴ to H⁷, |
| 7.43(m, 2H), 7.48(m, 1H), | 7.49(m, 2H) 7.50(m, 1H), | H^{4′} to H^{7′} ring |
| 7.56(m, 1H) | 7.62(m, 2H) | |

### Example 8

### Preparation of Rac and Meso Isomer of [Zr{Me₂Si(3-R′-(η⁵-C₉H₅)(3′-R″(η⁵-C₉H₅)}Cl₂]R′═CH₂CH₂CH₃, R″═CH₂CH₃ (18)

Sintesis of compound (18) was carried out in a similar manner as (12) using as reagents [Me₂Si(3-R′—C₉H₅)(3-R″C₉H₅)]R′═CH₂CH₂CH₃; R″═CH₂CH₃ (5.48 g, 15.25 mmol), nBuLi (1.60 M in hexane) (22.88 ml, 36.60 mmol) and ZrCl₄ (3.55 g, 15.25 mmol).

The desired compound was obtained as an orange solid (32% yield) shown to be a mixture of rac/meso isomers and identified by ¹HNMR analysis.

The separation of the two isomers was achieved by repeated fractional recrystallization from cold toluene (−30° C.).

One sample was isolated as (91:9 rac/meso) mixture.

¹H NMR(CDCl₃) rac isomer: δ(ppm) 1.10 (s,3H,MeSi), 1.12 (s,3H,MeSi), 1.21,1.11(t,3H,3H,CH₃—CH₂— Et an Pro chain), 1.60(m,2H,CH₃CH₂CH₂), 2.78 (m,2H,2H,CH₂ Et and Pro chain), 5.70 (s,1H,H² one indene ring), 5.73(s,1H,H² other indene ring) 7.08, 7.31 (dd,2H,2H H⁵ and H⁶), 7.45, 7.51 (d,2H,2H H⁴ and H⁷ indene ring).

### Example 9

### Preparation of Rac/Meso isomers of [Zr{(3-R-(η⁵-C₉H₅)—CH₂CH₂-(3-R-η⁵-C₉H₅}Cl₂]R═CH₂CH₃ (19)

Over an stirred solution of 3.14 g of [(3-R—C₉H₆)—CH₂—CH₂-(3-R—C₉H₆)—]R═CH₂CH₃ (6) in an Et₂O/THF mixture (20 ml/5 ml) maintained at 0° C. 8.8 ml 2.5M nBuLi solution in hexane is added over 20 minutes period. Temperature was allowed to raise after addition was finished and stirring continued for 2 more hours.

All the solvents were stripped off under vacuo and the resulting solid reslurried in 30 ml toluene and finally cooled at −78° C. ZrCl₄ (1.3 g) was added and the final suspension stirred for 15 hours.

The resulting reaction mixture was filtered over Celite, toluene stripped under reduced pressure and the solid obtained resluirried in hexane and filtered. The yellow-orange solid was purified by extraction with a mixture of toluene/hexane, filtered and crystallized at −20° C.

The desired compound was obtained in a 32% yield as a racemic/meso mixture of isomers 51:49

¹HNMR(mixture of isomers): δ(ppm) 1.11,1.21 (rac,meso,t,6H;CH₃); 2.78,2.95 (q,4H,rac/meso CH₂—CH₃); 3.60,4.00 (m,4H,meso CH₂—CH₂-bridge); 3.65,3.78 (m,4H,rac CH₂—CH₂-bridge); 6.00 (s,1H,rac ring H₂ ); 6.16 (s,1H,meso ring H²); 7.29 (m,1H); 7.36 (m,1H); 7.38 (m,1H); 7.42 (m,1H); 7.53 (m,1H); 7.55 (m,1H); 7.61 (m,1H); 7.63 (m,1H) (rac and meso ring protons H⁴ to H⁷, H^{4′} to H^{7′})

### Example 10

### Preparation of Rac/Meso Isomers of [Zr{(3-R-(η⁵-C₉H₅)—CH₂CH₂-(3-R-η⁵-C₉H₅}Cl₂]R═CH₂CH₂CH₂CH₂CH₃ (20)

Compound (20) was synthesized in a similar manner as that described above for the n-Butyl derivative.

It was also isolated as a racemic/meso mixture of isomers in 35% yield as a rac/meso mixture of isomers 52:48 rac:meso.

¹HNMR (mixture of isomers): δ(ppm) 0.87,0.92 (t,6H;CH₃); 1.28-1.60(mixture of multiplets,8H,CH₂—CH₂—CH₂—CH₃); 2.62,2.95 (m,4H,meso CH₂—CH₂—CH₂—CH₃); 2.8-2.9 (m,4H,rac CH₂—CH₂—CH₂—CH₃); 3.60,4.03 (m,4H,meso CH₂—CH₂— bridge); 3.70-3.80 (m,4H,rac CH₂—CH₂— bridge); 5.99 (s,1H,rac ring H²); 6.15 (s,1H,meso ring H²); 7.29 (m,1H); 7.36 (m,1H);7.38 (m,1H); 7.42 (m,1H); 7.53 (m,1H); 7.55 (m,1H); 7.61 (m,1H); 7.63 (m,1H) (rac and meso ring protons H⁴ to H⁷, H^{4′} to H^{7′})

Preparation of Supported Catalyst with Pure Metallocene Rac or Meso Isomers

### Example 11

### Preparation of Supported meso dimethylsilylbis(3-Methyl-1indenyl)zirconium dichloride.

All operations were performed under inert conditions using standard Schlenk techniques or dry box under nitrogen.

To 3.5 ml of 30% MAO (methylalumoxane available from Albemarle) a 10 ml toluene solution of 37 mg of meso-[Zr{Me₂Si(3-CH₃-(η⁵-C₉H₅))₂}Cl₂] synthesized in Example 1 as a 5:95 rac:meso mixture was added and the mixture was stirred 20 minutes. A light red solution is formed.

The metallocene MAO solution was added to 2 gram Davison 2908 silica dried at 400° C. contained in a flask provided with a mechanical agitator. The resulting slurry was stirred for 2 hours more at room temperature. Toluene was eliminated under vacuo and the solid dried for 16 hours at room temperature to give 2.8 g of a pink-salmon free flowing solid.

### Example 12

### Preparation of Supported rac dimethylsilyl(Indenyl)(3-Ethyl-1indenyl)zirconium dichloride.

rac dimethylsilyl(Indenyl)(3-Ethyl-1indenyl)zirconium dichloride was supported in a manner similar to that used in Example 11 except using 37 mg of [Zr{Me₂Si(3-CH₃CH₂-(η⁵-C₉H₅)(η⁵-C₉H₆)}Cl₂] synthesized in Example 7 in a 98:2 (rac:meso) molar proportion.

### Example 13

### Preparation of Supported meso dimethylsilyl(Indenyl)(3-Ethyl-1indenyl)zirconium dichloride.

meso dimethylsilyl(Indenyl)(3-Ethyl-1indenyl)zirconium dichloride was supported in a manner similar to that used in Example 11 except using 37 mg of [Zr{Me₂Si(3-CH₃CH₂-(η⁵-C₉H₅)(η⁵-C₉H₆)}Cl₂] synthesized in Example 7 in a 2:98 (rac:meso) molar proportion.

### Example 14

### Preparation of Supported meso dimethylsilyl(Indenyl)(3-Propyll-1indenyl)zirconium dichloride.

meso dimethylsilyl(1-Indenyl)(3-Ethyl-1indenyl)zirconium dichloride was supported in a manner similar to that used in Example 11 except using 38 mg of [Zr{Me₂Si(3-CH₃CH₂CH₂-(η⁵-C₉H₅)(η⁵-C₉H₆)}Cl₂] synthesized in Example 6 in a 1:99 (rac:meso) molar proportion.

### Example 15

### Preparation of Supported rac dimethylsilyl(Indenyl)(3-Propyl-1indenyl)zirconium dichloride.

rac dimethylsilyl(Indenyl)(3-Ethyl-1indenyl) zirconium dichloride was supported in a manner similar to that used in Example 10 except using 38 mg of [Zr{Me₂Si(3-CH₃CH₂CH₂-(η⁵-C₉H₅)(η⁵-C₉H₆)}Cl₂] synthesized in Example 6 in a 99:1 (rac:meso) molar proportion.

### Example 16

### Preparation of Supported rac dimethylsilyl (3-Ethyl-1-Indenyl)(3-Propyl-1indenyl)zirconium dichloride.

rac dimethylsilyl(3-Ethyl-Indenyl)(3-Propyl-1indenyl)zirconium dichloride was supported in a manner similar to that used in Example 11 except using 40 mg of [Zr{Me₂Si(3-CH₃CH₂-η⁵-C₉H₅)(3-CH₃CH₂-CH₂-η⁵-C₉H₆)}Cl₂] synthesized in Example 8 in a 91:9 (rac:meso) molar proportion.

Polymerization with supported catalysts from metallocenes as racemic or meso isomers.

### Example 17

### Polymerization Using Supported meso dimethylsilylbis(3-Methyl-1 indenyl)zirconium dichloride.

Copolymerization of ethylene and 1-hexene was carried out in a Büchi glass pressure reactor of 1.3 liters equipped with a mechanical agitator under anhydrous conditions. Reactor was charged with 600 ml of dry heptane,10 ml of hexene, 4 ml of a TIBA 1M solution, equilibrated at the desired temperature (85° C.) and finally pressurized with ethylene (3,5 bar).

80 mg supported meso dimethylsilylbis(3-Methyl-1indenyl)zirconium dichloride as prepared in Example 11 contained in a pressure tube was injected as a slurry in heptane by flushing with ethylene until the final desired pressure (4 bar) was reached.

Polymerization reaction was maintained at constant pressure (4 bar) and with temperature regulation at 85° C. for 30 minutes. At the end of polymerization time reactor was cooled and depressurized and the polymer was recovered by pouring the reactor content over acidified methanol and filtering.

The polymer was then dried for at least 20 hour in a vacuum oven at 40° C. Activity as gram PE/gram of supported catalyst per hour is given.

Activity 360 gPE/g catalyst×hour.

Main Polymer properties and type of molecular weight distribution is given in Table 1.

### Example 18-20

Polymerization was performed in the same manner as that described in Example 17 but using instead the following supported metallocenes:

### Example 18

### Supported rac dimethylsilyl(1-indenyl)(3-Ethyl-1indenyl)zirconium dichloride as prepared in Example 12. Activity 740 gPE/g catalyst per hour

### Example 19

### Supported meso dimethylsilyl(1-Indenyl)(3-Ethyl-1indenyl)zirconium dichloride as prepared in Example 13. Activity 190 gPE/g catalyst per hour

### Example 20

### Supported meso dimethylsilyl(1-indenyl)(3-Propyl-1indenyl)zirconium dichloride as prepared in Example 14. Activity 350 gPE/g catalyst per hour

### Example 21

### Supported rac dimethylsilyl(1-indenyl)(3-Propyl-1indenyl)zirconium dichloride as prepared in Example 15. Activity 1100 gPE/g catalyst per hour

### Example 22

### Supported rac dimethylsilyl(3Ethyl-1-indenyl)(3-Propyl-1indenyl)zirconium dichloride as prepared in Example 16. Activity 598 gPE/g catalyst per hour

TABLE I

| METALOCENE | | | | | COPOLYMER | | | | |
|---|---|---|---|---|---|---|---|---|---|
| Q | R1 | R2 | Example | Rac:Meso | MI | FI | Mw | Mw/Mn | GPC type (a) |
| Si | Me | Me | 17 | 5:95 | 1.70 | 19.1 | 86540 | 3.24 | Narrow: I |
| Si | H | Et | 19 | 2:98 | 0 | 3.27 | — | — | |
| Si | H | Pr | 20 | 1:99 | 11.6 | — | 63100 | 1.87 | Narrow: I |
| Si | H | Et | 18 | 98:2 | 0 | 0.95 | — | — | |
| Si | H | Pr | 21 | 99:1 | 7.5 | — | 70300 | 2.86 | Narrow: I |
| Si | Et | Pr | 22 | 91:9 | 1.4 | 17.8 | — | — | — |

(a) See GPC types FIG. 2, 3, 4, 5. The figures show typical representative GPC traces found for the polymers obtained with the types of metallocenes of the present invention tested along the span of the work and are not necessarily associated with the specific example shown in the Table being here incorporated for illustrative purposes.

As Table I shows molecular weight of the PE copolymers obtained with structurally similar metallocenes (Examples 18-21-22 (rac isomers) and 17-19-20 (meso isomers)) are high when Ethyl is the 3-substituent (low MI) and unexpectedly significantly lower when Propyl is the substituent as MI values confirm. The same tendency will be apparent when analyzing additional results from examples below when using isomeric mixtures in Table II: when substituent is Me or Et, PE molecular weight obtained is high. For larger than ethyl substituent (propyl or butyl) molecular weight of PE obtained is significantly lower. Interestingly and useful enough and this is one of the teaching of the present invention is that a wide range of molecular weight (co)polymers can be made with the metallocenes of the invention without the need to use molecular weight regulators by judicious selection of the substituent and type of substitution.

As a way of illustration: In example 18 with ethyl substituent Mw of the obtained copolymer is high (MI=0), for Pr (Example 21) MI is significantly higher with a 7.5 value while for the “mixed” Et-Pr (Example 22) an intermediate value of 1.4 is obtained.

Molecular weight distribution of PE copolymers obtained with the metallocenes used as racemic or meso pure isomers is narrow being of the type I shown in FIG. 2.

Meso isomer metallocenes of this invention produce polymers with lower molecular weight than their corresponding rac isomers counterparts. The differences between molecular weight of the produced polymers with meso versus rac metallocene isomers depends on the type of metallocene structure being larger when disubstituted metallocenes are used than when monosubstituted are used instead as will be shown below.

All these findings allow the preparation of very different molecular weight and molecular weight distribution ethylene polymers by proper combination of different variables associated with metallocene structure: isomer type content (rac or meso substantially pure isomer or mixtures of both ); substituent size (“short”: Me, Et or “large”: propyl and larger for example); substitution type: mono or disubstitution, being one of the object of the present invention and will be more fully illustrated below.

Preparation of Supported Catalyst with Metallocenes Used as Mixtures of Rac and Meso Isomers

### Examples 23-32

Supported catalyst of examples 23-33 were prepared in a similar manner as that of Example 11 but using instead:

### Example 23

### 38 mg of dimethylsilylbis(3-Methyl-1indenyl)zirconium dichloride as prepared in Example 1 and isolated as a 53:47 rac:meso molar proportion

### Example 24

### 38 of dimethylsilylbis(3-Methyl-1indenyl)zirconium dichloride as prepared in Example 1 and isolated as a 20:80 rac:meso molar proportion

### Example 25

### 38 of dimethylsilylbis(3-Methyl-1indenyl)zirconium dichloride as prepared in Example 1 and isolated as a 13:87 rac:meso molar proportion

### Example 26

### 37 mg dimethylsilylbis(3-Ethyl-1indenyl)zirconium dichloride as prepared in Example 2 and isolated as a 9:91 rac:meso molar proportion

### Example 27

### 37 mg dimethylsilylbis(3-Ethyl-1indenyl)zirconium dichloride as prepared in Example 2 and isolated as a 50:50 rac:meso molar proportion

### Example 28

### 41 mg dimethylsilylbis(3-Propyl-1indenyl)zirconium dichloride as prepared in Example 3 and isolated as a 59:41 rac:meso molar proportion

### Example 29

### 44 mg dimethylsilylbis(3-Butyl-1indenyl)zirconium dichloride as prepared in Example 4 and isolated as a 58:42 rac:meso molar proportion

### Example 30

### 37 mg dimethylsilyl(1-indenyl) (3-Ethyl-1indenyl)zirconium dichloride as prepared in Example 7 and isolated as a 55:45 rac:meso molar proportion

### Example 31

### 38 mg dimethylsilyl(1-indenyl) (3-Propyl-1indenyl)zirconium dichloride as prepared in Example 6 and isolated as a 55:45 rac:meso molar proportion

### Example 32

### 36 mg 1,2-Ethylenebis(3-Ethyl-1indenyl)zirconium dichloride as prepared in Example 9 and isolated as a 51:49 rac:meso molar proportion

### Example 33

### 41 mg 1,2-Ethylenebis(3-Butyl-1indenyl)zirconium dichloride as prepared in Example 10 and isolated as a 50:50 rac:meso molar proportion

### Comparative Example A

### 35 mg dimethylsilylbis (1-indenyl)zirconium dichloride as 99:1 rac:meso molar proportion

Polymerization with supported catalysts made with metallocenes as mixture of racemic or meso isomers.

### Example 34-40

Polymerization was performed in the same manner as that described in Example 17 but using instead the following supported metallocenes. Found activity is given:

### Example 34

### Supported dimethylsilylbis(3-Methyl-1indenyl)zirconium dichloride as prepared in Example 23.Activity 209 gPE/gcatalyst per hour

### Example 35

### Supported dimethylsilylbis(3-Methyl-1indenyl)zirconium dichloride as prepared in Example 24. Activity 288 gPE/gcatalyst per hour

### Example 36

### Supported dimethylsilylbis(3-Methyl-1indenyl)zirconium dichloride as prepared in Example 25. Activity 320 gPE/gcatalyst per hour

### Example 37

### Supported dimethylsilylbis(3-Ethyl-1indenyl)zirconium dichloride as prepared in Example 26. Activity 465 gPE/gcatalyst per hour

### Example 38

### Supported dimethylsilylbis(3-Ethyl-1indenyl)zirconium dichloride as prepared in Example 27. Activity 309 gPE/gcatalyst per hour

### Example 39

### Supported dimethylsilylbis(3-Propyl-1indenyl)zirconium dichloride as prepared in Example 28. Activity 655 gPE/gcatalyst per hour

### Example 40

### Supported dimethylsilylbis(3-Butyl-1indenyl)zirconium dichloride as prepared in Example 29. Activity 498 gPE/gcatalyst per hour

### Example 41

### Supported dimethylsilyl (1-Indenyl)(3-Ethyl-1indenyl)zirconium dichloride as prepared in Example 30. Activity 734 gPE/gcatalyst per hour

### Example 42

### Supported dimethylsilyl(1-Indenyl)(3-Propyl-1indenyl)zirconium dichloride as prepared in Example 31. Activity 629 gPE/gcatalyst per hour

### Example 43

### Supported 1,2-Ethylenebis(3-Ethyl-1indenyl)zirconium dichloride as prepared in Example 33. Activity 201 gPE/gcatalyst per hour

### Example 44

### Supported 1,2-Ethylenebis((3-Butyl-1indenyl)zirconium dichloride as prepared in Example 30. Activity 204 gPE/gcatalyst per hour

### Comparative Example B

### Supported dimethylsilylbis(1-indenyl)zirconium dichloride as prepared in Comparative Example A. Activity 405 gPE/gcatalyst per hour

Polymer properties obtained with above supported metallocenes are shown in TABLE II. Results show that optional substituted metallocenes of the invention present higher activities than non substituted comparative example. The molecular weight of the polymers obtained with metallocenes with Me or Et substituents is higher than the obtained with non substituted comparative example and much higher than the obtained with metallocenes containing larger than ethyl as substituents.

Additionally, different molecular weight distribution polymers can be obtained by proper combination of metallocene type substituent and type of isomer being used as substantially pure stereoisomer or in mixtures.

TABLE II

| METALLOCENE | | | | | POLYMER PROPERTIES | | | | |
|---|---|---|---|---|---|---|---|---|---|
| Q | R¹ | R² | Ex. N^{o} | Rac:Mes | MI | FI | Mw | Mw/Mn | GPC type (a) |
| Si | Me | Me | 34 | 53:47 | 0 | 1 | | | Broad bimodal: TypeIII |
| Si | Me | Me | 35 | 20:80 | 0 | 4.4 | 279000 | 14.31 | Broad bimodal: TypeIII |
| Si | Me | Me | 36 | 13:87 | 0.29 | 64 | 213000 | 17.2 | Broad Bimodal: TypeIII |
| Si | Et | Et | 37 | 9:91 | 0 | 13.4 | 248000 | 21.7 | Broad Bimodal: TypeIII |
| Si | Et | Et | 34 | 50:50 | 0 | 1 | | — | — |
| Si | Pr | Pr | 35 | 59:41 | 5.8 | — | 81300 | 3.35 | Broad: Type II |
| Si | Bu | Bu | 36 | 58:42 | 7.83 | — | 51080 | 4.6 | Broad: Type II |
| Si | H | Et | 37 | 55:45 | 0.96 | — | — | — | — |
| Si | H | Pr | 38 | 40:60 | 17.22 | — | 50900 | 3.69 | Bimodal: Type IV |
| Et | Et | Et | 39 | 51:49 | 0 | 3.3 | — | — | — |
| Et | Bu | Bu | 40 | 50:50 | 5 | 121 | — | — | — |
| Si | H | H | Comp | 99:1 | 3.25 | 56.3 | 175100 | 5.69 | — |

(a) See GPC types FIG. 3, 4, 5, 6. The figures show typical representative GPC traces found for the polymers obtained with the types of metalocenes of the present invention tested along the span of the work and are not necessarily associated with the specific example shown in the Table being here incorporated for illustrative purposes.

While the present invention has been described and illustrated making reference to particular embodiments specifically by the provided examples those of ordinary skill in the art will appreciate that the invention itself will lead to variation and combination of the various teaching and results not necessarily illustrated herein.

1. A bridged metallocene compound containing two substituted indenyl ligands joined by a ridging group and complexed to a metal atom of formula (I): 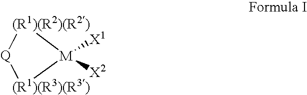
wherein:
M is a transition metal atom selected from the group consisting of the atoms of Group 4 of the Periodic Table;
R¹ is an indenyl ligand;
Q is a divalent group of formula ═SiR⁴R⁵ or —CH R⁴—CH R⁵—; wherein R⁴ and R⁵ are, independently, hydrogen atoms or monovalent radicals selected from halogen, C₁-C₂₀ alkyl, C₆-C₂₀ aryl, C₂-C₂₀ alkenyl, C₇-C₂₀ arylalkyl and C₇-C₂₀ alkylaryl, optionally containing oxygen and/or silicon atoms as substituents;
R² and R³ bonded to R¹ at position 3 are, independently, hydrogen or a radical Rₐ, wherein Rₐ is a monovalent organic radical selected from C₁-C₂₀ alkyl, C₂-C₂₀ alkenyl and C₇-C₂₀ alkylaryl, said monovalent organic radical optionally containing oxygen and/or silicon atoms as substituents which are not bonded directly to the cyclopentadienyl ring moiety;
R^{2′} and R^{3′} bonded to R¹ at position 2 are, independently, hydrogen or a radical Rₐ, wherein Rₐ is as defined above;
wherein at least one of R² and R³is Rₐ, and
when R² is Rₐ, then R^{2′} is H, or
when R³ is Rₐ, then R^{3′} is H, and
when R² and R³ independently are both Rₐ, then R^{2′} and R^{3′} are simultaneously H, with the proviso that
when R^{2′} and R^{3′} are simultaneously hydrogen, then R² and R³ are not simultaneously methyl (Me), iso-propyl (i-Pr) or tert-butyl (t-Bu) for rac isomer; or
when R^{2′} and R^{3′} are simultaneously hydrogen, M is Zr or Hf, X¹ and X² are both Cl and Q is ═SiMe₂, then R² and R³ are not simultaneously pentenyl for rac and meso isomers;
or when R^{2′} and R^{3′} are simultaneously hydrogen, M is Zr, X¹ and X² are both Cl and Q is ═SiMe₂, then R² and R³ are not simultaneously para-tolyl for rac and meso isomers;
or when R² is H then R³ is not Me, or when R² is Me then R³ is not H for rac and meso isomers;
or when R², R^{2′}, R^{3′} are H, M is Zr, X¹ and X² are both Cl and Q is ═SiMe₂, then R³ is not benzyl, or when R² is benzyl, R^{2′} and R^{3′} are both H, M is Zr, X¹ and X² are both Cl and Q is ═SiMe₂, then R³ is not H for rac and meso isomers; and
X¹ and X² are, independently, monovalent ligands selected from hydrogen, halogen, C₁-C₂₀ alkyl, C₆-C₂₀ aryl, C₇-C₂₀ alkylaryl, C₇-C₂₀ arylalkyl, C₁-C₂₀ hydrocarbyloxy, C₆-C₂₀ aryloxy, C₁-C₂₀ di(alkyl)amido and carboxylate;
its racemic or meso stereoisomers and mixtures thereof.

2. A bridged metallocene compound according to claim 1, wherein:
M is Ti, Zr or Hf,
R¹ is an indenyl ligand;
R^{2′} and R^{3′} bonded to R¹ at position 2 are both hydrogen;
R² and R³ bonded to R¹ at position 3 are, independently, selected from H or C₂-C₂₀ linear alkyl group, with the proviso that at least one of R² or R³ are C₂-C₂₀ linear alkyl group;
Q is a divalent group of formula ═SiR⁴R⁵ or —CHR⁴—CHR⁵—; wherein R⁴ and R⁵ are, independently, hydrogen atoms or monovalent radicals selected from halogen, C₁-C₂₀ alkyl, C₆-C₂₀ aryl, C₂-C₂₀ alkenyl, and C₇-C₂₀ alkylaryl, optionally containing oxygen and silicon atoms as substituents;
X¹ and X² are the same or different monovalent ligands selected from the halogens.

3. Metallocene compound according to claim 1, wherein the bridged metallocene is a rac stereoisomer.

4. Metallocene compound according to claim 1, wherein the bridged metallocene is a mixture of rac and meso stereoisomers.

5. Metallocene compound according to claim 1, selected from the group consisting of:
Meso dimethylsilanediylbis(1-indenyl-3-methyl)zirconium dichloride
Rac and meso dimethylsilanediylbis(1-indenyl-3-ethyl)zirconium dichloride
Rac and meso dimethylsilanediylbis(1-indenyl-3-propyl)zirconium dichloride
Rac and meso dimethylsilanediylbis(1-indenyl-3-butyl)zirconium dichloride
Rac and meso dimethylsilanediylbis(1-indenyl-3-pentyl)zirconium dichloride
Rac and meso dimethylsilanediylbis(1-indenyl-3-hexyl)zirconium dichloride
Rac and meso 1,2 ethanediylbis(1-indenyl-3-ethyl)zirconium dichloride
Rac and meso 1,2 ethanediylbis(1-indenyl-3-propyl)zirconium dichloride
Rac and meso 1,2 ethanediylbis(1-indenyl-3-butyl)zirconium dichloride
Rac and meso 1,2 ethanediylbis(1-indenyl-3-pentyl)zirconium dichloride
Rac and meso 1,2 ethanediylbis(1-indenyl-3-hexyl)zirconium dichloride
Rac and meso dimethylsilanediyl(1-indenyl)(1-indenyl-3-ethyl)zirconium dichloride
Rac and meso dimethylsilanediyl(1-indenyl)(1-indenyl-3-propyl)zirconium dichloride
Rac and meso dimethylsilanediyl(1-indenyl)(1-indenyl-3-butyl)zirconium dichloride
Rac and meso dimethylsilanediyl(1-indenyl)(1-indenyl-3-pentyl)zirconium dichloride
Rac and meso dimethylsilanediyl(1-indenyl)(1-indenyl-3-hexyl)zirconium dichloride
Rac and meso 1,2 ethanediyl(1-indenyl)(1-indenyl-3-methyl)zirconium dichloride
Rac and meso 1,2 ethanediyl(1-indenyl)(1-indenyl-3-ethyl)zirconium dichloride
Rac and meso 1,2 ethanediyl(1-indenyl)(1indenyl-3-propyl)zirconium dichloride
Rac and meso 1,2 ethanediyl(1-indenyl)(1-indenyl-3-butyl)zirconium dichloride
Rac and meso 1,2 ethanediyl(1-indenyl)(1-indenyl-3-pentyl)zirconium dichloride
Rac and meso 1,2 ethanediyl(1-indenyl)(1-indenyl-3-hexyl)zirconium dichloride
Rac and meso phenylmethylsilanediyl(1-indenyl)(1-indenyl-3-methyl)zirconium dichloride
Rac and meso phenylmethylsilanediyl(1-indenyl)(1-indenyl-3-ethyl)zirconium dichloride
Rac and meso phenylmethylsilanedyil(1-indenyl)(1-indenyl-3-propyl)zirconium dichloride
Rac and meso phenylmethylsilanediyl(1-indenyl)(1-indenyl-3-butyl)zirconium dichloride
Rac and meso phenylmethylsilanediyl(1-indenyl)(1-indenyl-3-pentyl)zirconium dichloride
Rac and meso phenylmethylsilanediyl(1-indenyl)(1-indenyl-3-hexyl)zirconium dichloride
Rac and meso dimethylsilanediyl(1-indenyl-3-methyl)(1-indenyl-3-ethyl)zirconium dichloride
Rac and meso dimethylsilanediyl(1-indenyl-3-methyl)(1-indenyl-3-propyl)zirconium dichloride
Rac and meso dimethylsilanediyl(1-indenyl-3-methyl)(1-indenyl-3-butyl)zirconium dichloride
Rac and meso dimethylsilanediyl(1-indenyl-3-methyl)(1-indenyl-3-pentyl)zirconium dichloride
Rac and meso dimethylsilanediyl(1-indenyl-3-methyl)(1-indenyl-3-hexyl)zirconium dichloride
Rac and meso dimethylsilanediyl(1-indenyl-3-ethyl)(1-indenyl-3-propyl)zirconium dichloride
Rac and meso dimethylsilanediyl(1-indenyl-3-ethyl)(1-indenyl-3-butyl)zirconium dichloride
Rac and meso dimethylsilanediyl(1-indenyl-3-ethyl)(1-indenyl-3-pentyl)zirconium dichloride
Rac and meso dimethylsilanediyl(1-indenyl-3-ethyl)(1-indenyl-3-hexyl)zirconium dichloride
Rac and meso 1,2 ethanediyl(1-indenyl-3-methyl)(1-indenyl-3-ethyl)zirconium dichloride
Rac and meso 1,2 ethanediyl(1-indenyl-3-methyl)(1-indenyl-3-propyl)zirconium dichloride
Rac and meso 1,2 ethanediyl(1-indenyl-3-methyl)(1-indenyl-3-butyl)zirconium dichloride
Rac and meso 1,2 ethanediyl(1-indenyl-3-methyl)(1-indenyl-3-pentyl)zirconium dichloride
Rac and meso 1,2 ethanediyl(1-indenyl-3-methyl)(1-indenyl-3-hexyl)zirconium dichloride
Rac and meso 1,2 ethanediyl(1-indenyl-3-ethyl)(1-indenyl-3-propyl)zirconium dichloride
Rac and meso ethylenebis(1-indenyl-3-ethyl)(1-indenyl-3-butyl)zirconium dichloride
Rac and meso ethylenebis(1-indenyl-3-ethyl)(1-indenyl-3-pentyl)zirconium dichloride
Rac and meso ethylenebis(1-indenyl-3-ethyl)(1-indenyl-3-hexyl)zirconium dichloride
Rac and meso dimethylsilanediyl(1-indenyl-3-methyl)(1-indenyl-3-ethyl-4,7-dimethyl)zirconium dichloride
Rac and meso dimethylsilanediyl(1-indenyl, 3-methyl)(1-indenyl-3-propyl, 4,7-dimethyl)zirconium dichloride
Rac and meso dimethylsilanediyl(1-indenyl-3-methyl)(1-indenyl-3-butyl-4,7-dimethyl)zirconium dichloride
Rac and meso dimethylsilanediyl(1-indenyl-3-methyl)(1-indenyl-3-ethyl-4-phenyl)zirconium dichloride
Rac and meso dimethylsilanediyl(1-indenyl-3-methyl)(1-indenyl-3-propyl-4-phenyl)zirconium dichloride
Rac and meso dimethylsilanediyl(1-indenyl-3-methyl)(1-indenyl-3-butyl-4-phenyl)zirconium dichloride
Rac and meso dimethylsilanediyl(1-indenyl-3-ethyl)(1-indenyl-3-propyl-4-phenyl)zirconium dichloride
Rac and meso dimethylsilanediyl(1-indenyl-3-ethyl)(1-indenyl-3-butyl-4-phenyl)zirconium dichloride
Rac and meso dimethylsilanediyl(1-indenyl-3-ethyl)(1-indenyl-3-propyl-4,7-dimethyl)zirconium dichloride
Rac and meso dimethylsilanediyl(1-indenyl-3-ethyl)(1-indenyl-3-butyl-4,7-dimethyl)zirconium dichloride
Rac and meso dimethylsilanediyl(1-indenyl-2-methyl)(1-indenyl-3-methyl)zirconium dichloride
Rac and meso dimethylsilanediyl(1-indenyl-2-methyl)(1-indenyl-3-ethyl)zirconium dichloride
Rac and meso dimethylsilanediyl(1-indenyl-2-methyl)(1-indenyl-3-propyl)zirconium dichloride.
Rac and meso dimethylsilanediyl(1-indenyl-2-ethyl)(1-indenyl-3-ethyl)zirconium dichloride
Rac and meso dimethylsilanediyl(1-indenyl-2-ethyl)(1-indenyl-3-propyl)zirconium dichloride
Rac and meso 1,2 ethanediyl(1-indenyl-2-methyl)(1-indenyl-3-propyl)zirconium dichloride.
Rac and meso 1,2 ethanediyl(1-indenyl-2-ethyl)(1-indenyl-3-ethyl)zirconium dichloride
Rac and meso 1,2 ethanediyl(1-indenyl-2-ethyl)(1-indenyl-3-propyl)zirconium dichloride

6. A racemic stereoisomer of the bridged metallocene compound of claim 1, of formula (II): 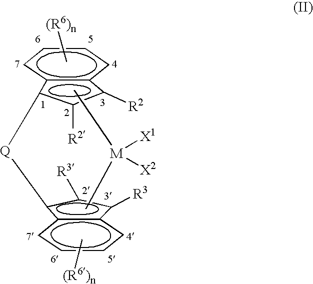
wherein:
M, R², R³, R^{2′}, R^{3′}, Q, X¹ and X² are as defined in claim 1;
R⁶ and R⁶′ are independently methyl or phenyl; and
n and n′ are independently 0, 1 or 2.

7. A meso stereoisomer of the bridged metallocene compound of claim 1, of formula (III): 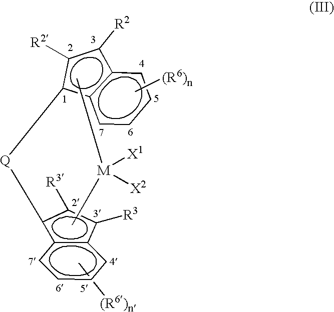
wherein:
M, R², R³, R^{2′}, R^{3′}, Q, X¹ and X² are as defined in claim 1;
R⁶ and R⁶′ are, independently, methyl or phenyl; and
n and n′ are, independently, 0, 1 or 2.

8. Racemic or meso stereoisomer, selected from the group consisting of compounds of formula (II) and formula (III), wherein n and n′ are 0.

9. Racemic or meso stereoisomer according to claim 6 wherein R² and R³ are independently selected from the group formed by hydrogen, methyl, ethyl, propyl, butyl, pentyl and hexyl.

10. Racemic or meso stereoisomer according to claim 7 wherein R² and R³ are independently selected from the group formed by hydrogen, methyl, ethyl, propyl, butyl, pentyl and hexyl.

11. Racemic or meso stereoisomer according to claim 6 wherein Q is a phenylmethylsilanediyl group, dimethylsilanediyl group or a 1,2 ethanediyl group.

12. Racemic or meso stereoisomer according to claim 7 wherein Q is a phenylmethylsilanediyl group, dimethylsilanediyl group or a 1,2 ethanediyl group.

13. A composition comprising a mixture of at least one racemic stereoisomer of formula (IIa) and at least one meso stereoisomer of formula (IIIa): 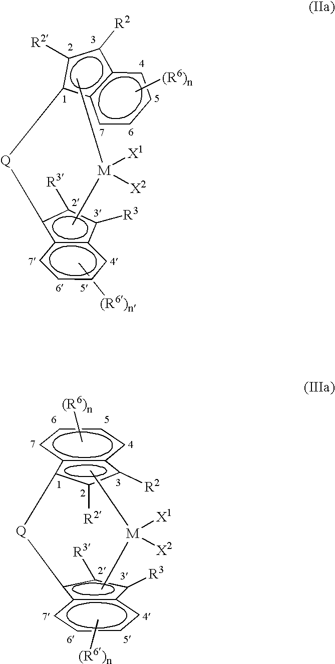
wherein:
M, Q, X¹ and X² are as defined in claim 1;
R² and R³ bonded to the indenyl ligand at position 3 are, independently, hydrogen or a radical Rₐ, wherein Rₐ is a monovalent organic radical selected from C₁-C₂₀ alkyl, C₂-C₂₀ alkenyl, and C₇-C₂₀ alkylaryl, said monovalent organic radical optionally containing oxygen and/or silicon atoms as substituents which are not bonded directly to the cyclopentadienyl ring moiety;
R^{2′} and R^{3′} bonded to the indenyl ligand at position 2 are, independently, hydrogen or a radical Rₐ, wherein Rₐ is as defined above;
wherein at least one of R² and R³ is Rₐ, and
when R² is Rₐ, then R^{2′} is H,
when R³ is Rₐ, then R^{3′} is H, and
when R² and R³ independently are Rₐ, then R^{2′} and R^{3′} are simultaneously H;
R⁶ and R⁶′ are, independently, methyl or phenyl; and
n and n′ are, independently, 0, 1 or 2.

14. Composition according to claim 13, which comprises a compound of formula (IIa) and/or a compound of formula (IIIa), wherein R² and R³ are, independently, selected from the group formed by hydrogen, methyl, ethyl, propyl, butyl, pentyl and hexyl.

15. Composition according to claim 13, which comprises a compound of formula (IIa) and/or a compound of formula (IIIa), wherein Q is a phenylmethylsilanediyl group, a dimethylsilylene group or an ethylidene group.

16. A polymerization catalyst system comprising: a) (i) at least one metallocene compound as claimed in claim 1 or (ii) a mixture of at least one racemic stereoisomer of formula (IIa) and at least one meso stereoisomer of formula (IIIa): 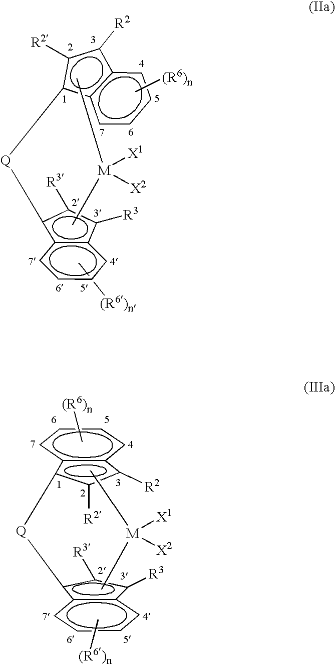
wherein:
M, Q, X¹ and X² are as defined in claim 1;
R² and R³ bonded to the indenyl ligand at position 3 are, independently, hydrogen or a radical Rₐ, wherein Rₐ is a monovalent organic radical selected from C₁-C₂₀ alkyl, C₂-C₂₀ alkenyl, and C₇-C₂₀ alkylaryl, said monovalent organic radical optionally containing oxygen and/or silicon atoms as substituents which are not bonded directly to the cyclopentadienyl ring moiety;
R^{2′} and R³⁺ bonded to the indenyl ligand at position 2 are, independently, hydrogen or a radical Rₐ, wherein Rₐ is as defined above;
wherein at least one of R² and R³ is Rₐ, and
when R² is Rₐ, then R^{2′} is H,
when R³ is Rₐ, then R^{3′} is H, and
when R² and R³ independently are Rₐ, then R^{2′} and R^{3′} are simultaneously H;
R⁶ and R⁶′ are, independently, methyl or phenyl; and
n and n′ are, independently, 0, 1 or 2; and
b) a co-catalyst.

17. Polymerization catalyst system according to claim 16, wherein the co-catalyst is an aluminoxane selected from the group consisting of methyl-aluminoxane and modified methylaluminoxane, or a compound capable of forming an alkyl metallocene cation.

18. A heterogeneous polymerization catalyst system which comprises a polymerization catalyst system according to claim 16, and a support.

19. A process for the polymerization of C₂-C₂₀ alpha-olefins or for the copolymerization of ethylene and C₃-C₂₀ alpha-olefins which comprises the use of a polymerization catalyst system according to claim 16.

20. The process of claim 19, wherein ethylene is copolymerized with an alpha-olefin selected from propylene, 1-butene, 1-hexene, 1-octene and mixtures thereof.

21. A polyethylene resin produced by the process of claim 19.

22. A process for polymerization of C₂-C₂₀ alpha-olefins or for copolymerization of ethylene and C₃-C₂₀ alpha-olefins, comprising use of the catalyst system of claim 16.
